(19) United States
(12) Patent Application Publication
(10) Pub. No.: US 2023/0162219 A1
(43) Pub. Date: May 25, 2023

(54) COMPUTER-READABLE RECORDING MEDIUM STORING INFORMATION PROCESSING PROGRAM, INFORMATION PROCESSING METHOD, AND INFORMATION PROCESSING SYSTEM

(71) Applicant: FUJITSU LIMITED, Kawasaki-shi (JP)

(72) Inventors: Hayato Dan, Yokohama (JP); Masatoshi OGAWA, Zama (JP); Natsuki Ishikawa, Yamato (JP)

(73) Assignee: FUJITSU LIMITED, Kawasaki-shi (JP)

(21) Appl. No.: 17/950,184

(22) Filed: Sep. 22, 2022

(30) Foreign Application Priority Data
Nov. 25, 2021 (JP) 2021-191379

(51) Int. Cl. G06Q 30/02; G06Q 30/06

(52) U.S. Cl. CPC G06Q 30/0206; G06Q 30/0633

(57) ABSTRACT

A recording medium stores an information processing program causing a computer to execute a process including: acquiring a first order quantity from an order receiving side to an ordering side and a first profit amount distributed from the order receiving side to the ordering side, calculated by using a first parameter including first confidential information; acquiring a second order quantity from the order receiving side to the ordering side and a second profit amount distributed from the order receiving side to the ordering side, calculated by using a second parameter including second confidential information; calculating a first penalty based on the first order quantity, the first profit amount, the second order quantity, and the second profit amount; notifying the order receiving side to calculate the first order quantity and the first profit amount; and notifying the ordering side to calculate the second order quantity and the second profit amount.

### CROSS-REFERENCE TO RELATED APPLICATION

This application is based upon and claims the benefit of priority of the prior Japanese Patent Application No. 2021-191379, filed on Nov. 25, 2021, the entire contents of which are incorporated herein by reference.

### FIELD

The embodiments discussed herein are related to a non-transitory computer-readable recording medium storing an information processing program, an information processing method, and an information processing system.

### BACKGROUND

In the related art, a system called a supply chain is formed by an order receiving side that manufactures a product and an ordering side that requests the manufacture. There is a case where each of two parties of the order receiving side and the ordering side independently determines a price of the product to be sold to the ordering side and a quantity of the product requested to be manufactured by the order receiving side so as to maximize a profit. For example, there is a case where an order receiving side determines a price of a product to be sold to an ordering side so as to maximize a profit of the order receiving side, and the ordering side determines a quantity of the product requested to be manufactured by the order receiving side so as to maximize a profit of the ordering side. In this case, a situation called double marginalization in which it is difficult to maximize a profit of the entire supply chain is likely to occur.

Japanese National Publication of International Patent Application No. 2004-517378 and Japanese Laid-open Patent Publication No. 2004-035219 are disclosed as related art.

Li, Mengmou, et al. “Smooth dynamics for distributed constrained optimization with heterogeneous delays.” IEEE Control Systems Letters 4.3 (2020): 626-631 is also disclosed as related art.

### SUMMARY

According to an aspect of the embodiments, a non-transitory computer-readable recording medium stores an information processing program causing a computer to execute a process including: acquiring a first order quantity from an order receiving side to an ordering side and a first profit amount distributed from the order receiving side to the ordering side, which are calculated by the order receiving side by using a first parameter including first confidential information owned by the order receiving side, from the order receiving side; acquiring a second order quantity from the order receiving side to the ordering side and a second profit amount distributed from the order receiving side to the ordering side, which are calculated by the ordering side by using a second parameter including second confidential information owned by the ordering side, from the ordering side; calculating a first penalty that acts to reduce a difference between the first order quantity and the second order quantity and a difference between the first profit amount and the second profit amount, based on the acquired first order quantity, the acquired first profit amount, the acquired second order quantity, and the acquired second profit amount; notifying the order receiving side to calculate the first order quantity and the first profit amount by using the first parameter including the calculated first penalty; and notifying the ordering side to calculate the second order quantity and the second profit amount by using the second parameter including the calculated first penalty.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system;

FIG. 3 is a block diagram illustrating a hardware configuration example of a management side apparatus;

FIG. 4 is a block diagram illustrating a hardware configuration example of an order receiving side apparatus;

FIG. 5 is a block diagram illustrating a hardware configuration example of an ordering side apparatus;

FIG. 6 is a block diagram illustrating an example of a functional configuration of an information processing system;

FIG. 7 is a block diagram illustrating a specific example of the functional configuration of the information processing system;

FIG. 8 is an explanatory diagram (part 1) illustrating a first operation example of the information processing system;

FIG. 9 is an explanatory diagram (part 2) illustrating the first operation example of the information processing system;

FIG. 10 is an explanatory diagram (part 3) illustrating the first operation example of the information processing system;

FIG. 11 is an explanatory diagram (part 4) illustrating the first operation example of the information processing system;

FIG. 12 is an explanatory diagram (part 1) illustrating a second operation example of the information processing system;

FIG. 13 is an explanatory diagram (part 2) illustrating the second operation example of the information processing system;

FIG. 14 is an explanatory diagram illustrating an example of effects obtained by the information processing system;

FIG. 15 is a flowchart illustrating an example of an order receiving side calculation process procedure;

FIG. 16 is a flowchart illustrating an example of an ordering side calculation process procedure;

FIG. 17 is a flowchart illustrating an example of a first penalty calculation process procedure; and

FIG. 18 is a flowchart illustrating an example of a second penalty calculation process procedure.

### DESCRIPTION OF EMBODIMENTS

As the related art, for example, there is a technique for obtaining an optimum configuration for a process in a supply chain model by considering an optimum condition for the supply chain model. For example, there is a technique for determining an improvement item in a supply chain when the supply chain is to be improved from profit and loss information of the entire supply chain. For example, there is a technique for causing a plurality of systems to calculate a formulated evaluation function and a constraint condition in a distributed manner, for an optimization problem.

Meanwhile, in the related art, it is difficult to maximize the profit of the entire supply chain. For example, without referring to concealed information owned by the order receiving side and concealed information owned by the ordering side, it is difficult to determine a price of the product sold to the ordering side and a quantity of the product requested to be manufactured by the order receiving side so as to maximize the profit of the entire supply chain.

According to one aspect, an object of the present disclosure is to maximize a profit in an entire system without disclosing confidential information.

Hereinafter, embodiments of an information processing program, an information processing method, and an information processing system according to the present disclosure are described in detail with reference to the drawings.

(Example of Information Processing Method According to Embodiment)

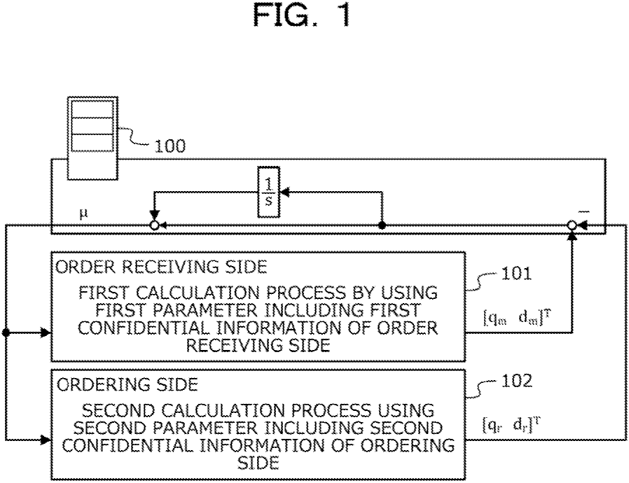

FIG. 1 is an explanatory diagram illustrating an example of an information processing method according to an embodiment. An information processing apparatus 100 is a computer for maximizing a profit in an entire predetermined system. The information processing apparatus 100 is, for example, a server, a personal computer (PC), or the like.

For example, the predetermined system is a system formed by an order receiving side and an ordering side. For example, the predetermined system is a supply chain. Ordering is to request a predetermined number of resources from the order receiving side. A resource is, for example, a physical resource. The physical resource is, for example, a product. The resource may be a human resource, a spatial resource, a calculation resource, or the like. The predetermined number is called, for example, an order quantity.

The order receiving side is, for example, a manufacturing side that manufactures a product. The ordering side is, for example, a requesting side that requests the manufacturing. For example, the ordering side is a retail side that purchases a product and sells the product to a consumer. The order receiving side may be a wholesaler, in some cases. The order receiving side may be a wholesaler and the ordering side is an intermediate wholesaler, in some cases. A profit of the entire predetermined system is, for example, a sum of a profit of an order receiving side and a profit of an ordering side that form the predetermined system.

There is a case where each of two parties of the order receiving side and the ordering side independently determines a price of the product to be sold to the ordering side and a quantity of the product requested to be manufactured by the order receiving side so as to maximize a profit. For example, there is a case where an order receiving side determines a price of a product to be sold to an ordering side so as to maximize a profit of the order receiving side, and the ordering side determines a quantity of the product requested to be manufactured by the order receiving side so as to maximize a profit of the ordering side. In this case, there is a problem that a situation called double marginalization in which it is difficult to maximize a profit of an entire supply chain is likely to occur.

Meanwhile, it is difficult to maximize the profit of the entire supply chain. For example, without referring to confidential information owned by the order receiving side and confidential information owned by the ordering side, a price of the product sold to the ordering side and a quantity of the product requested to be manufactured by the order receiving side may be determined so as to maximize the profit of the entire supply chain. The confidential information is information that is not preferable to be disclosed to others, from the viewpoint of protection of know-how, protection of personal information, or the like.

A method is conceivable in which an ordering side receives confidential information owned by an order receiving side and determines a price of a product sold to the ordering side and a quantity of products requested to be manufactured by the order receiving side so as to maximize a profit of the entire supply chain. According to this method, since the confidential information owned by the order receiving side is disclosed to the ordering side, the order receiving side is likely to suffer from disadvantages, which is not preferable. Another problem is that a risk occurs that the confidential information owned by the order receiving side is leaked from the ordering side.

In the same manner, another method is conceivable in which an order receiving side receives confidential information owned by an ordering side and determines a price of a product sold to the ordering side and a quantity of products requested to be manufactured by the order receiving side so as to maximize a profit of the entire supply chain. Also in this method, since the confidential information owned by the ordering side is disclosed to the order receiving side, the ordering side is likely to be disadvantageous, which is not preferable. Another problem is that a risk occurs that confidential information owned by the ordering side is leaked from the order receiving side.

Still another method is conceivable in which confidential information owned by an order receiving side and confidential information owned by an ordering side are provided to a neutral computation device that belongs to neither the order receiving side nor the ordering side. According to this method, the computation device determines a price of a product sold to the ordering side and a quantity of products requested to be manufactured by the order receiving side so as to maximize the profit of the entire supply chain. Also in this method, since the confidential information owned by the order receiving side and the confidential information owned by the ordering side are disclosed to the computation device, both the order receiving side and the ordering side are likely to suffer from disadvantages, which is not preferable. Another problem is that a risk occurs that the confidential information owned by the order receiving side and the confidential information owned by the ordering side are leaked from the computation device.

Accordingly, it is desirable that both the order receiving side and the ordering side do not disclose the confidential information, and the profit is maximized in the entire system. Therefore, in the present embodiment, an information processing method will be described with which it is possible to maximize a profit in an entire system without both an order receiving side and an ordering side disclosing confidential information.

As illustrated in FIG. 1, there are an order receiving side 101 and an ordering side 102. For example, the ordering side 102 is a selling side that sells a product to a consumer. For example, the order receiving side 101 is a manufacturing side that manufactures a product and provides the manufactured product to the ordering side.

The order receiving side 101 has first confidential information. For example, the first confidential information includes a cost of a product, and an original profit obtained by the order receiving side. By using a first parameter including the first confidential information, the order receiving side 101 may execute a first calculation process of calculating a first order quantity qₘ from the order receiving side to the ordering side and a first profit amount dₘ distributed from the order receiving side to the ordering side. The first parameter may include a penalty. The first order quantity qₘ is a provisional order quantity. For example, the first profit amount dₘ is a provisional profit amount.

The ordering side 102 has second confidential information. For example, the second confidential information includes demand information of the product and an original profit obtained by the ordering side. By using a second parameter including the second confidential information, the ordering side 102 may execute a second calculation process of calculating a second order quantity qᵣ from the order receiving side to the ordering side and a second profit amount dᵣ distributed from the order receiving side to the ordering side. The second parameter may include a penalty. The second order quantity qᵣ is a provisional order quantity. For example, the second profit amount dᵣ is a provisional profit amount.

(1-1) The information processing apparatus 100 acquires, from the order receiving side 101, the first order quantity qₘ from the order receiving side 101 to the ordering side 102 and the first profit amount dₘ distributed from the order receiving side 101 to the ordering side 102, which are calculated by the order receiving side 101 using the first parameter. For example, the information processing apparatus 100 receives a first transposed matrix [qₘ dₘ]^{T} including the first order quantity qₘ and the first profit amount dₘ from the order receiving side 101.

(1-2) The information processing apparatus 100 acquires, from the ordering side 102, the second order quantity qᵣ from the order receiving side 101 to the ordering side 102 and the second profit amount dᵣ distributed from the order receiving side 101 to the ordering side 102, which are calculated by the ordering side 102 using the second parameter. For example, the information processing apparatus 100 receives a second transposed matrix [qᵣ dᵣ]^{T} including the second order quantity qᵣ and the second profit amount dᵣ from the ordering side 102.

(1-3) The information processing apparatus 100 calculates a first penalty µ based on the acquired first order quantity qₘ, first profit amount dₘ, second order quantity qᵣ, and second profit amount dᵣ. The first penalty µ acts to reduce various differences such as a difference between the first order quantity qₘ and the second order quantity qᵣ and a difference between the first profit amount dₘ and the second profit amount dᵣ. For example, the first penalty µ acts to reduce various differences in each of the first calculation process and the second calculation process.

For example, by including the first penalty µ in the first parameter, the first penalty µ acts to enable calculation of the first order quantity qₘ and the first profit amount dₘ so as to reduce various differences in the first calculation process. For example, by including the first penalty µ in the second parameter, the first penalty µ acts to enable calculation of the second order quantity qᵣ and the second profit amount dᵣ so as to reduce various differences in the second calculation process.

For example, the information processing apparatus 100 calculates the first penalty µ by adding a difference value obtained by subtracting the second transposed matrix [qᵣ dᵣ]^{T} from the first transposed matrix [qₘ dₘ]^{T} and an integral value of the difference value. Therefore, the information processing apparatus 100 may obtain the first penalty µ serving as a guideline indicating how to adjust the first order quantity qₘ, the first profit amount dₘ, the second order quantity qᵣ, and the second profit amount dᵣ without referring to the first confidential information and the second confidential information.

(1-4) The information processing apparatus 100 notifies the order receiving side 101 to calculate the first order quantity qₘ and the first profit amount dₘ by using the first parameter including the calculated first penalty µ. For example, the information processing apparatus 100 transmits a notification including the first penalty µ to the order receiving side 101. Therefore, the information processing apparatus 100 may cause the order receiving side 101 to calculate the first order quantity qₘ and the first profit amount dₘ again so as to reduce the various differences.

(1-5) The information processing apparatus 100 notifies the ordering side 102 to calculate the second order quantity qᵣ and the second profit amount dᵣ by using the second parameter including the calculated first penalty µ. For example, the information processing apparatus 100 transmits a notification including the first penalty µ to the ordering side 102. Therefore, the information processing apparatus 100 may cause the ordering side 102 to calculate the second order quantity qᵣ and the second profit amount dᵣ again so as to reduce the various differences.

Therefore, the information processing apparatus 100 may reduce various differences such as the difference between the first order quantity qₘ and the second order quantity qᵣ and the difference between the first profit amount dₘ and the second profit amount dᵣ without directly referring to the first confidential information and the second confidential information. For this reason, with the information processing apparatus 100, the order receiving side 101 may avoid disclosure of the first confidential information, a risk of leakage of the first confidential information may be suppressed, and the order receiving side 101 may be less likely to suffer from disadvantages. In the same manner, with the information processing apparatus 100, the ordering side 102 may avoid disclosure of the second confidential information, a risk of leakage of the second confidential information may be suppressed, and the ordering side 102 may be less likely to suffer from disadvantages.

Although the case where the information processing apparatus 100 calculates the first penalty µ once is described, the embodiment is not limited thereto. For example, the information processing apparatus 100 may repeatedly acquire the first order quantity qₘ and the first profit amount dₘ calculated by the order receiving side 101 and the second order quantity qᵣ and the second profit amount dᵣ calculated by the ordering side 102, and repeatedly calculate the first penalty µ, in some cases.

For example, every time the information processing apparatus 100 makes a notification to the order receiving side 101, the information processing apparatus 100 acquires the first order quantity qₘ and the first profit amount dₘ calculated by the order receiving side 101 in accordance with the notification. Every time the information processing apparatus 100 makes a notification to the ordering side 102, the information processing apparatus 100 acquires the second order quantity qᵣ and the second profit amount dᵣ calculated by the ordering side 102 in accordance with the notification. Every time the first order quantity qₘ, the first profit amount dₘ, the second order quantity qᵣ, and the second profit amount dᵣ are acquired, the information processing apparatus 100 calculates the first penalty µ and notifies the order receiving side 101 and the ordering side 102 of the first penalty µ.

Although the case where the information processing apparatus 100 operates alone is described above, the information processing apparatus 100 is not limited to this. For example, a function as the information processing apparatus 100 may be implemented by a plurality of computers, in some cases. For example, the function as the information processing apparatus 100 may be implemented by a cloud, in some cases.

### Example of Information Processing System 200

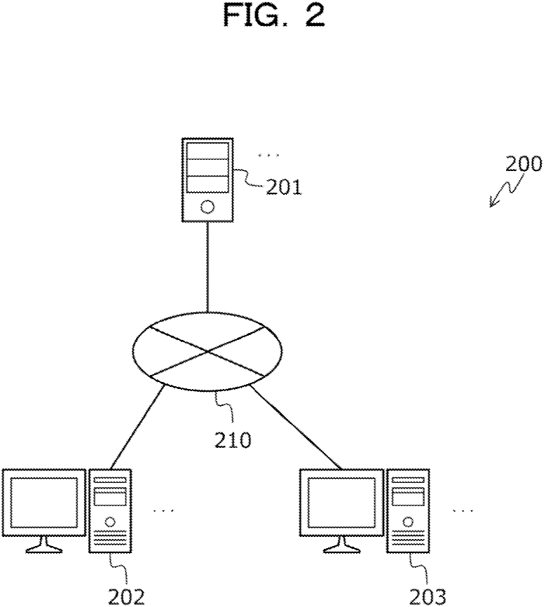

Next, an example of an information processing system 200 to which the information processing apparatus 100 illustrated in FIG. 1 is applied will be described by using FIG. 2.

FIG. 2 is an explanatory diagram illustrating an example of the information processing system 200. As illustrated in FIG. 2, the information processing system 200 includes a management side apparatus 201, an order receiving side apparatus 202, and an ordering side apparatus 203.

In the information processing system 200, the management side apparatus 201 and the order receiving side apparatus 202 are coupled to each other via a wired or wireless network 210. The network 210 is, for example, a local area network (LAN), a wide area network (WAN), Internet, or the like. In the information processing system 200, the management side apparatus 201 and the ordering side apparatus 203 are coupled to each other via the wired or wireless network 210.

The management side apparatus 201 is a computer that does not belong to an ordering side or an order receiving side. The ordering side is, for example, a selling side that sells a product to a consumer. The order receiving side is, for example, a manufacturing side that manufactures a product and provides the manufactured product to the ordering side. For example, the management side apparatus 201 corresponds to the information processing apparatus 100 illustrated in FIG. 1.

The management side apparatus 201 acquires the first order quantity qₘ and the first profit amount dₘ calculated by the order receiving side apparatus 202 by using a first parameter from the order receiving side apparatus 202. The management side apparatus 201 acquires, from the order receiving side apparatus 202, a first ratio πₘ(qₘ, dₘ)/tₘ of a provisional profit πₘ(qₘ, dₘ) to an original profit tₘ of the order receiving side calculated by the order receiving side apparatus 202 by using the first parameter.

From the ordering side apparatus 203, the management side apparatus 201 acquires the second order quantity qᵣ and the second profit amount dᵣ calculated by the ordering side apparatus 203 by using a second parameter. From the ordering side apparatus 203, the management side apparatus 201 acquires a second ratio πᵣ(qᵣ, dᵣ)/tᵣ of a provisional profit πᵣ(qᵣ, dᵣ) to an original profit tᵣ of the ordering side calculated by the ordering side apparatus 203 by using the second parameter.

Based on the acquired first order quantity qₘ, first profit amount dₘ, second order quantity qᵣ, and second profit amount dᵣ, the management side apparatus 201 calculates the commonization penalty µ. The commonization penalty µ corresponds to the first penalty µ illustrated in FIG. 1. The commonization penalty µ acts on the order receiving side and the ordering side so as to reduce a difference between the first order quantity qₘ and the second order quantity qᵣ and a difference between the first profit amount dₘ and the second profit amount dᵣ.

Based on the acquired first ratio πₘ(qₘ, dₘ)/tₘ and second ratio πᵣ(qᵣ, dᵣ)/tᵣ, the management side apparatus 201 calculates a profit ratio penalty v. The profit ratio penalty v acts on the order receiving side and the ordering side so as to reduce a difference between the first ratio πₘ(qₘ, dₘ)/tₘ and the second ratio πᵣ(qᵣ, dᵣ)/tᵣ.

By using the first parameter including the calculated commonization penalty µ and profit ratio penalty v, the management side apparatus 201 notifies the order receiving side apparatus 202 to calculate the first order quantity qₘ, the first profit amount dₘ, and the first ratio πₘ(qₘ, dₘ)/tₘ. For example, the management side apparatus 201 transmits a notification including the commonization penalty µ and the profit ratio penalty v to the order receiving side apparatus 202.

By using the second parameter including the calculated commonization penalty µ and profit ratio penalty v, the management side apparatus 201 notifies the ordering side apparatus 203 to calculate the second order quantity qᵣ, the second profit amount dᵣ, and the second ratio πᵣ(qᵣ, dᵣ)/tᵣ. For example, the management side apparatus 201 transmits a notification including the commonization penalty µ and the profit ratio penalty v to the ordering side apparatus 203.

The management side apparatus 201 may repeatedly execute a series of processes described above. For example, the management side apparatus 201 repeatedly executes the series of processes described above until the first order quantity qₘ and the first profit amount dₘ, the second order quantity qᵣ and the second profit amount dᵣ, and the first ratio πₘ(qₘ, dₘ)/tₘ and the second ratio πᵣ(qᵣ, dᵣ)/tᵣ converge. The convergence is a state in which the first order quantity qₘ and the second order quantity qᵣ coincide with each other, the first profit amount dₘ and the second profit amount dᵣ coincide with each other, and the first ratio πₘ(qₘ, dₘ)/tₘ and the second ratio πᵣ(qᵣ, dᵣ)/tᵣ coincide with each other.

For example, the management side apparatus 201 is a server, a PC, or the like. The management side apparatus 201 may be implemented by a microcomputer, a programmable logic controller (PLC), or the like, in some cases.

The order receiving side apparatus 202 is a computer belonging to the order receiving side. The order receiving side apparatus 202 is used by an order receiving side user, for example. The order receiving side apparatus 202 has first confidential information to be used as a first parameter. For example, the first confidential information includes a cost of a product and the original profit tₘ obtained by the order receiving side. The order receiving side apparatus 202 stores the commonization penalty µ and the profit ratio penalty v to be used as the first parameter.

The order receiving side apparatus 202 executes a first calculation process of calculating the first order quantity qₘ, the first profit amount dₘ, and the first ratio πₘ(qₘ, dₘ)/tₘ by using the first parameter. The order receiving side apparatus 202 transmits the calculated first order quantity qₘ, first profit amount dₘ, and first ratio πₘ(qₘ, dₘ)/tₘ to the management side apparatus 201. The order receiving side apparatus 202 receives a notification including the commonization penalty µ and the profit ratio penalty v from the management side apparatus 201. The order receiving side apparatus 202 updates the commonization penalty µ and the profit ratio penalty v included in the first parameter to the commonization penalty µ and the profit ratio penalty v included in the received notification.

Until the first order quantity qₘ, the first profit amount dₘ, and the first ratio πₘ(qₘ, dₘ)/tₘ converge, the order receiving side apparatus 202 repeatedly executes a series of processes described above. For example, when the first order quantity qₘ, first profit amount dₘ, and first ratio πₘ(qₘ, dₘ)/tₘ calculated in the previous time coincide with the first order quantity qₘ, first profit amount dₘ, and first ratio πₘ(qₘ, dₘ)/tₘ calculated in the current time, the order receiving side apparatus 202 determines that the convergence is made. For example, the order receiving side apparatus 202 is a server, a PC, or the like. The order receiving side apparatus 202 may be implemented by a microcomputer, a PLC, or the like, in some cases.

The ordering side apparatus 203 is a computer belonging to the ordering side. The ordering side apparatus 203 is used by an ordering side user, for example. The ordering side apparatus 203 has second confidential information to be used as a second parameter. For example, the second confidential information includes demand information of a product and the original profit tᵣ obtained by the ordering side. The ordering side apparatus 203 stores the commonization penalty µ and the profit ratio penalty v to be used as the second parameter.

By using the second parameter, the ordering side apparatus 203 executes a second calculation process of calculating the second order quantity qᵣ, the second profit amount dᵣ, and the second ratio πᵣ(qᵣ, dᵣ)/tᵣ. The ordering side apparatus 203 transmits the calculated second order quantity qᵣ, second profit amount dᵣ, and second ratio πᵣ(qᵣ, dᵣ)/tᵣ to the management side apparatus 201. The ordering side apparatus 203 receives a notification including the commonization penalty µ and the profit ratio penalty v from the management side apparatus 201. The ordering side apparatus 203 updates the commonization penalty µ and the profit ratio penalty v included in the second parameter to the commonization penalty µ and the profit ratio penalty v included in the received notification.

Until the second order quantity qᵣ, the second profit amount dᵣ, and the second ratio πᵣ(qᵣ, dᵣ)/tᵣ converge, the ordering side apparatus 203 repeatedly executes a series of processes described above. For example, when the second order quantity qᵣ, second profit amount dᵣ, and second ratio πᵣ(qᵣ, dᵣ)/tᵣ calculated in the previous time coincide with the second order quantity qᵣ, second profit amount dᵣ, and second ratio πᵣ(qᵣ, dᵣ)/tᵣ calculated in the current time, the ordering side apparatus 203 determines that the convergence is made. For example, the ordering side apparatus 203 is a server, a PC, or the like. The ordering side apparatus 203 may be implemented by a microcomputer, a PLC, or the like, in some cases.

### Application Example of Information Processing System 200

Next, an application example of the information processing system 200 illustrated in FIG. 2 will be described. For example, the information processing system 200 may be applied to a case where an ordering side requests an order receiving side to provide a predetermined number of ordered physical resources. The physical resource is, for example, a product or the like. For example, the provision is selling. For example, the provision may be a loan, in some cases. Therefore, the information processing system 200 may appropriately adjust an order quantity of the physical resources to be provided by the order receiving side to the ordering side so as to maximize a profit of an entire supply chain.

For example, the information processing system 200 may be applied to a case where an ordering side requests an order receiving side to provide a predetermined number of ordered human resources. The human resource is, for example, an employee or the like. For example, the provision is a loan. Therefore, the information processing system 200 may appropriately adjust an order quantity of the human resources to be provided by the order receiving side to the ordering side so as to maximize a profit of an entire supply chain.

For example, the information processing system 200 may be applied to a case where an ordering side requests an order receiving side to provide a predetermined number of ordered spatial resources. The spatial resource is, for example, a warehouse or the like. For example, the provision is selling. For example, the provision may be a loan, in some cases. Therefore, the information processing system 200 may appropriately adjust an order quantity of the spatial resources to be provided by the order receiving side to the ordering side so as to maximize a profit of an entire supply chain.

For example, the information processing system 200 may be applied to a case where an ordering side requests an order receiving side to provide a predetermined number of ordered calculation resources. The calculation resource is, for example, a memory, a server, or the like. For example, the provision is selling. For example, the provision may be a loan, in some cases. Therefore, the information processing system 200 may appropriately adjust an order quantity of the calculation resources to be provided by the order receiving side to the ordering side so as to maximize a profit of an entire supply chain.

### Hardware Configuration Example of Management Side Apparatus 201

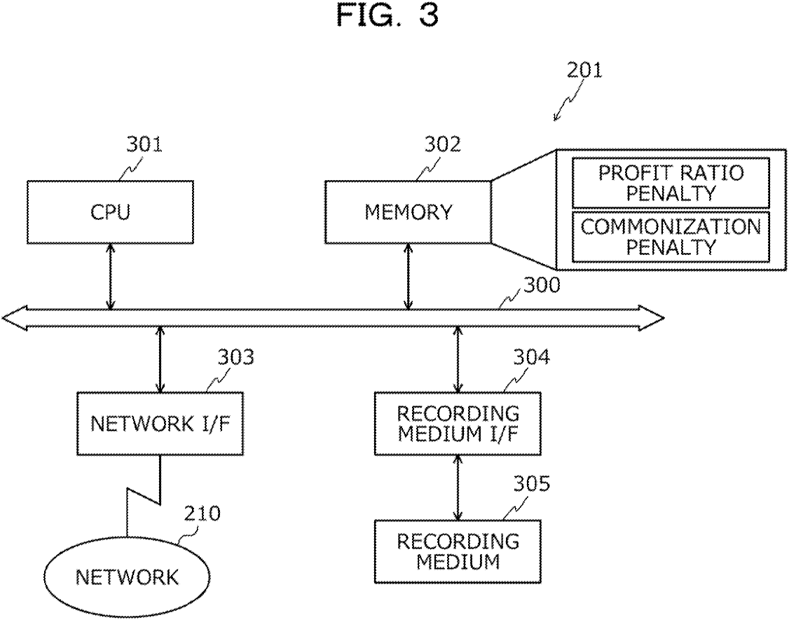

Next, a hardware configuration example of the management side apparatus 201 will be described with reference to FIG. 3.

FIG. 3 is a block diagram illustrating the hardware configuration example of the management side apparatus 201. In FIG. 3, the management side apparatus 201 includes a central processing unit (CPU) 301, a memory 302, a network interface (I/F) 303, a recording medium I/F 304, and a recording medium 305. The respective components are coupled to each other through a bus 300.

The CPU 301 controls the entire management side apparatus 201. The memory 302 includes, for example, a read-only memory (ROM), a random-access memory (RAM), a flash ROM, and the like. For example, the flash ROM or the ROM stores various programs, and the RAM is used as a work area of the CPU 301. The program stored in the memory 302 causes the CPU 301 to execute coded processes by being loaded into the CPU 301. The memory 302 stores a profit ratio penalty and a commonization penalty.

The network I/F 303 is coupled to the network 210 through a communication line, and is coupled to another computer via the network 210. The network I/F 303 controls an interface between the network 210 and internal components, and controls an input and an output of data from and to the another computer. The network I/F 303 is, for example, a modem, a LAN adapter, or the like.

The recording medium I/F 304 controls reading and writing of data from and to the recording medium 305 under the control of the CPU 301. The recording medium I/F 304 is, for example, a disk drive, a solid-state drive (SSD), a Universal Serial Bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be detachable from the management side apparatus 201.

In addition to the components described above, the management side apparatus 201 may include, for example, a keyboard, a mouse, a display, a printer, a scanner, a microphone, a speaker, and the like. The management side apparatus 201 may include a plurality of recording medium I/Fs 304 or a plurality of recording media 305. The management side apparatus 201 may not include the recording medium I/F 304 or the recording medium 305.

### Hardware Configuration Example of Order Receiving Side Apparatus 202

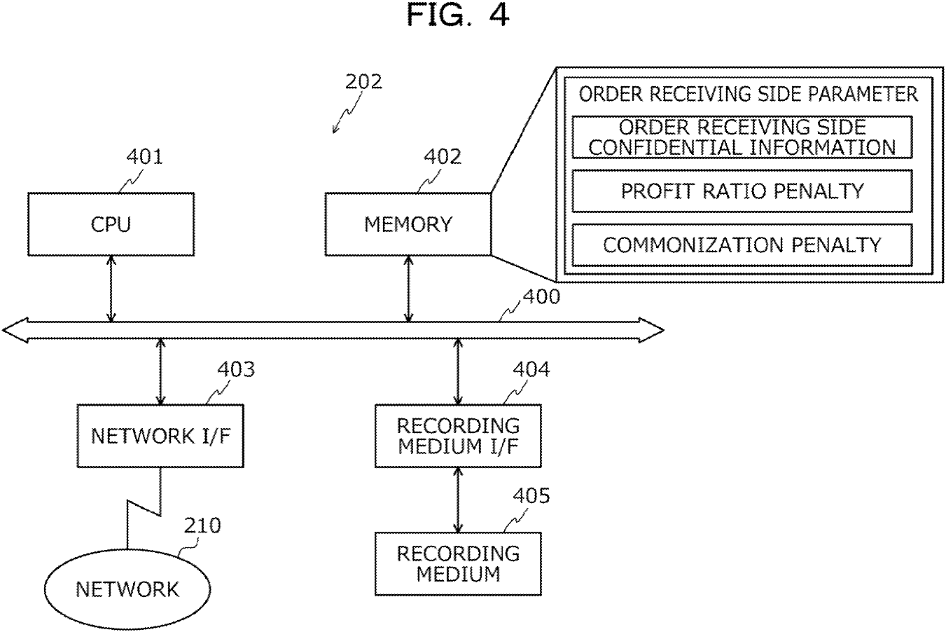

Next, a hardware configuration example of the order receiving side apparatus 202 will be described with reference to FIG. 4.

FIG. 4 is a block diagram illustrating the hardware configuration example of the order receiving side apparatus 202. In FIG. 4, the order receiving side apparatus 202 includes a CPU 401, a memory 402, a network I/F 403, a recording medium I/F 404, and a recording medium 405. The respective components are coupled to each other through a bus 400.

The CPU 401 controls the entire order receiving side apparatus 202. The memory 402 includes, for example, a ROM, a RAM, a flash ROM, and the like. For example, the flash ROM or the ROM stores various programs, and the RAM is used as a work area of the CPU 401. The programs stored in the memory 402 are loaded by the CPU 401 and cause the CPU 401 to execute coded processes.

The memory 402 stores an order receiving side parameter. For example, the order receiving side parameter corresponds to the first parameter described above. As the order receiving side parameter, for example, order receiving side confidential information is stored. For example, the order receiving side confidential information corresponds to the first confidential information described above. For example, the order receiving side confidential information includes a cost of a product and an original profit obtained by an order receiving side. As the order receiving side parameter, for example, a profit ratio penalty and a commonization penalty are stored.

The network I/F 403 is coupled to the network 210 through a communication line, and is coupled to another computer via the network 210. The network I/F 403 controls an interface between the network 210 and internal components, and controls an input and an output of data to and from the another computer. The network I/F 403 is, for example, a modem, a LAN adapter, or the like.

The recording medium I/F 404 controls reading and writing of data from and to the recording medium 405 under the control of the CPU 401. The recording medium I/F 404 is, for example, a disk drive, an SSD, a USB port, or the like. The recording medium 405 is a nonvolatile memory that stores data written under the control of the recording medium I/F 404. The recording medium 405 is, for example, a disk, a semiconductor memory, a USB memory, or the like. The recording medium 405 may be detachable from the order receiving side apparatus 202.

In addition to the components described above, the order receiving side apparatus 202 may include, for example, a keyboard, a mouse, a display, a printer, a scanner, a microphone, a speaker, and the like. The order receiving side apparatus 202 may include a plurality of recording medium I/Fs 404 or a plurality of recording media 405. The order receiving side apparatus 202 may not include the recording medium I/F 404 or the recording medium 405.

### Hardware Configuration Example of Ordering Side Apparatus 203

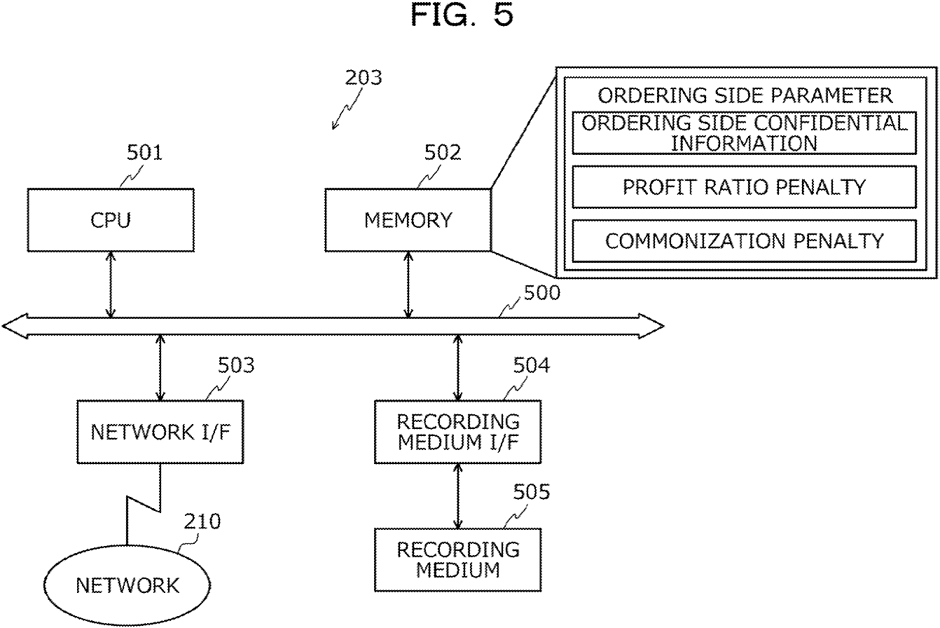

Next, a hardware configuration example of the ordering side apparatus 203 will be described with reference to FIG. 5.

FIG. 5 is a block diagram illustrating the hardware configuration example of the ordering side apparatus 203. As illustrated in FIG. 5, the ordering side apparatus 203 includes a CPU 501, a memory 502, a network I/F 503, a recording medium I/F 504, and a recording medium 505. The respective components are coupled to each other through a bus 500.

The CPU 501 controls the entire ordering side apparatus 203. The memory 502 includes, for example, a ROM, a RAM, a flash ROM, and the like. For example, the flash ROM or the ROM stores various programs, and the RAM is used as a work area of the CPU 501. The programs stored in the memory 502 are loaded by the CPU 501 and cause the CPU 501 to execute coded processes.

The memory 502 stores an ordering side parameter. For example, the ordering side parameter corresponds to the second parameter described above. As the ordering side parameter, for example, ordering side confidential information is stored. For example, the ordering side confidential information corresponds to the second confidential information described above. For example, the ordering side confidential information includes demand information of a consumer for a product and an original profit obtained by an ordering side. As the ordering side parameter, for example, a profit ratio penalty and a commonization penalty are stored.

The network I/F 503 is coupled to the network 210 through a communication line and is coupled to another computer via the network 210. The network I/F 503 controls an interface between the network 210 and internal components, and controls an input and an output of data to and from the another computer. The network I/F 503 is, for example, a modem, a LAN adapter, or the like.

The recording medium I/F 504 controls reading and writing of data from and to the recording medium 505 under the control of the CPU 501. The recording medium I/F 504 is, for example, a disk drive, an SSD, a USB port, or the like. The recording medium 505 is a nonvolatile memory that stores the data written under the control of the recording medium I/F 504. The recording medium 505 is, for example, a disk, a semiconductor memory, a USB memory, or the like. The recording medium 505 may be detachable from the ordering side apparatus 203.

In addition to the components described above, the ordering side apparatus 203 may include, for example, a keyboard, a mouse, a display, a printer, a scanner, a microphone, a speaker, and the like. The ordering side apparatus 203 may include a plurality of recording medium I/Fs 504 or a plurality of recording media 505. The ordering side apparatus 203 may not include the recording medium I/F 504 or the recording medium 505.

### Example of Functional Configuration of Information Processing System 200

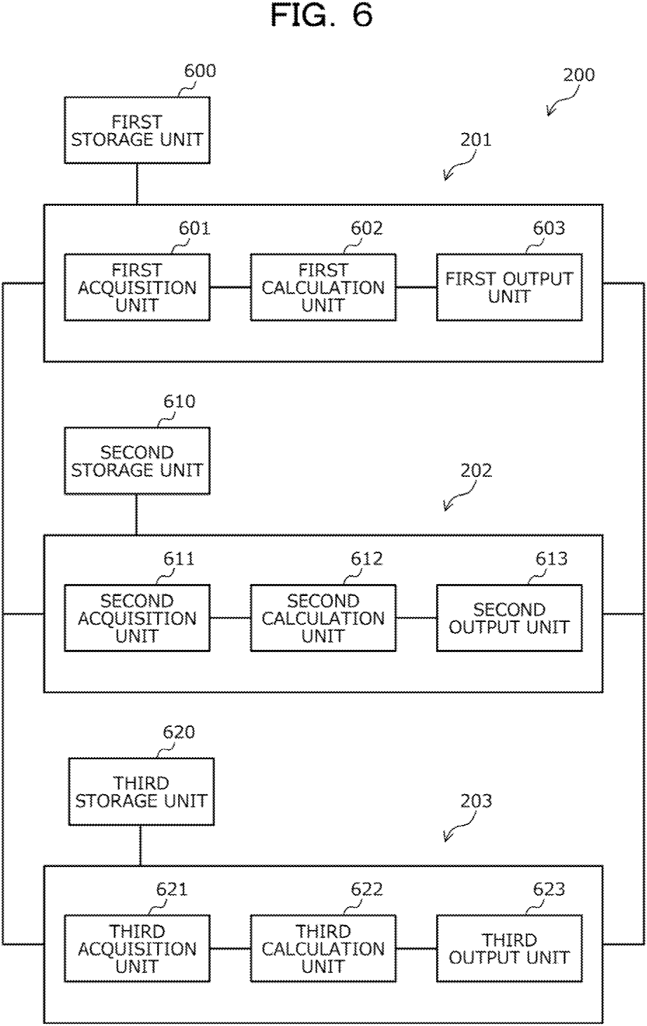

Next, an example of a functional configuration of the information processing system 200 will be described with reference to FIG. 6.

FIG. 6 is a block diagram illustrating the example of the functional configuration of the information processing system 200. As illustrated in FIG. 6, the management side apparatus 201 includes a first storage unit 600, a first acquisition unit 601, a first calculation unit 602, and a first output unit 603.

The first storage unit 600 is implemented by a storage region such as the memory 302 or the recording medium 305 illustrated in FIG. 3, for example. Hereinafter, a case where the first storage unit 600 is included in the management side apparatus 201 will be described, and the embodiment is not limited thereto. For example, in some cases, the first storage unit 600 may be included in an apparatus different from the management side apparatus 201 and contents stored in the first storage unit 600 may be referred to from the management side apparatus 201, in some cases.

The first acquisition unit 601 to the first output unit 603 function as an example of a control unit. For example, the functions of the first acquisition unit 601 and the first output unit 603 are implemented by causing the CPU 301 to execute a program stored in a storage region such as the memory 302 or the recording medium 305 illustrated in FIG. 3 or by using the network I/F 303. A process result by each functional unit is stored in, for example, the storage region such as the memory 302 or the recording medium 305 illustrated in FIG. 3.

The first storage unit 600 stores various types of information to be referred to or updated in a process performed by each functional unit. For example, the first storage unit 600 stores a first order quantity from an order receiving side to an ordering side and a first profit amount distributed from the order receiving side to the ordering side. The order receiving side is, for example, a providing side that provides a product to the ordering side. The ordering side is, for example, a selling side that sells a product to a consumer. For example, the first order quantity and the first profit amount are calculated by the order receiving side. For example, the first order quantity and the first profit amount are acquired by the first acquisition unit 601. For example, the first storage unit 600 stores a first ratio of a provisional profit obtained by the order receiving side to an original profit obtained by the order receiving side. For example, the first ratio is calculated by the order receiving side. For example, the first ratio is acquired by the first acquisition unit 601.

For example, the first storage unit 600 stores a second order quantity from the order receiving side to the ordering side and a second profit amount distributed from the order receiving side to the ordering side. For example, the second order quantity and the second profit amount are calculated by the ordering side. For example, the second order quantity and the second profit amount are acquired by the first acquisition unit 601. For example, the first storage unit 600 stores a second ratio of a provisional profit obtained by the ordering side to an original profit obtained by the ordering side. For example, the second ratio is calculated by the ordering side. For example, the second ratio is acquired by the first acquisition unit 601.

For example, the first storage unit 600 stores a first penalty acting to reduce a difference between the first order quantity and the second order quantity and a difference between the first profit amount and the second profit amount. The first penalty is the commonization penalty described above. For example, the first penalty is calculated by the first calculation unit 602. The first storage unit 600 stores a second penalty acting to reduce a difference between the first ratio and the second ratio. The second penalty is, for example, the profit ratio penalty described above. For example, the second penalty is calculated by the first calculation unit 602.

The first acquisition unit 601 acquires various types of information to be used in a process performed by each functional unit. The first acquisition unit 601 stores the acquired various types of information in the first storage unit 600, or outputs the acquired various types of information to each functional unit. The first acquisition unit 601 may output the various types of information stored in the first storage unit 600 to each functional unit. For example, the first acquisition unit 601 acquires various types of information based on an operation input by a management side user. For example, the first acquisition unit 601 may receive the various types of information from an apparatus different from the management side apparatus 201.

For example, the first acquisition unit 601 acquires, from the order receiving side, the first order quantity and the first profit amount calculated by the order receiving side by using a first parameter. For example, the first parameter includes first confidential information owned by the order receiving side. For example, the first confidential information includes a cost of a product, and the original profit obtained by the order receiving side. For example, the first penalty may be included in the first parameter. For example, the second penalty may be included in the first parameter.

For example, the first acquisition unit 601 acquires the first order quantity and the first profit amount by receiving the first order quantity and the first profit amount from the order receiving side. For example, the first acquisition unit 601 may acquire the first order quantity and the first profit amount calculated by the order receiving side by using the first parameter further including the first penalty, by receiving the first order quantity and the first profit amount from the order receiving side. For example, the first acquisition unit 601 may acquire the first order quantity and the first profit amount calculated by the order receiving side by using the first parameter further including the first penalty and the second penalty, by receiving the first order quantity and the first profit amount from the order receiving side.

For example, the first acquisition unit 601 acquires, from the ordering side, the second order quantity and the second profit amount calculated by the ordering side by using a second parameter. For example, the second parameter includes second confidential information owned by the ordering side. For example, the second confidential information includes demand information of a consumer for a product and the original profit obtained by the ordering side. For example, the first penalty may be included in the second parameter. For example, the second penalty may be included in the second parameter.

For example, the first acquisition unit 601 acquires the second order quantity and the second profit amount by receiving the second order quantity and the second profit amount from the ordering side. For example, the first acquisition unit 601 may acquire the second order quantity and the second profit amount calculated by the ordering side by using the second parameter further including the first penalty by receiving the second order quantity and the second profit amount from the ordering side. For example, the first acquisition unit 601 may acquire the second order quantity and the second profit amount calculated by the ordering side by using the second parameter further including the first penalty and the second penalty by receiving the second order quantity and the second profit amount from the ordering side.

For example, the first acquisition unit 601 acquires, from the order receiving side, the first ratio calculated by the order receiving side by using the first parameter. For example, the first acquisition unit 601 acquires the first ratio by receiving the first ratio from the order receiving side. For example, the first acquisition unit 601 may acquire the first ratio calculated by the order receiving side by using the first parameter including the first penalty, by receiving the first ratio from the order receiving side. For example, the first acquisition unit 601 may acquire the first ratio calculated by the order receiving side by using the first parameter including the first penalty and the second penalty, by receiving the first ratio from the order receiving side.

For example, the first acquisition unit 601 acquires, from the ordering side, the second ratio calculated by the ordering side by using the second parameter. For example, the first acquisition unit 601 acquires the second ratio by receiving the second ratio from the ordering side. For example, the first acquisition unit 601 may acquire the second ratio calculated by the ordering side by using the second parameter including the first penalty, by receiving the second ratio from the ordering side. For example, the first acquisition unit 601 may acquire the second ratio calculated by the ordering side by using the second parameter including the first penalty and the second penalty, by receiving the second ratio from the ordering side.

The first acquisition unit 601 may accept a start trigger for starting a process of any functional unit. For example, the start trigger is generated when a predetermined operation input is performed by the management side user. The start trigger may be, for example, receipt of predetermined information from another computer. The start trigger may be, for example, an output of predetermined information by any functional unit.

For example, the first acquisition unit 601 accepts the acquisition of the first order quantity, the first profit amount, the second order quantity, and the second profit amount as a start trigger for starting a process of the first calculation unit 602. For example, the first acquisition unit 601 accepts the acquisition of the first ratio and the second ratio as a start trigger for starting the process of the first calculation unit 602.

For example, every time the first order quantity, the first profit amount, the second order quantity, and the second profit amount are acquired, the first calculation unit 602 calculates the first penalty based on the first order quantity, the first profit amount, the second order quantity, and the second profit amount which are acquired in the current time. For example, the first calculation unit 602 calculates a difference value obtained by subtracting a second matrix including the acquired second order quantity and second profit amount from a first matrix including the acquired first order quantity and first profit amount. The first calculation unit 602 calculates the first penalty by adding the calculated difference value and an integral value of the difference value.

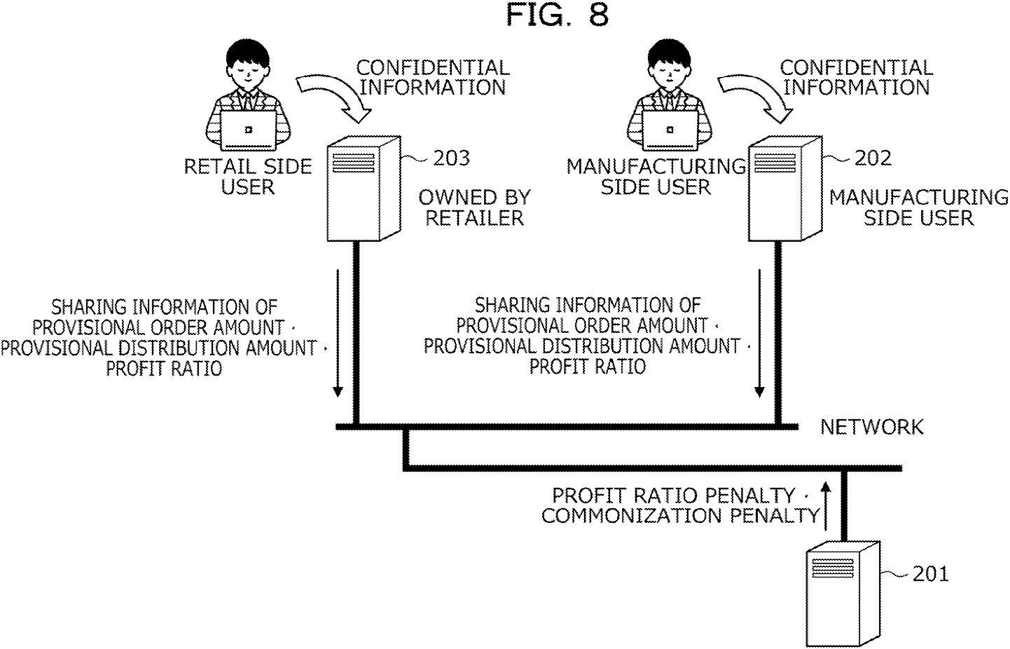

A specific example of calculating the first penalty will be described later with reference to FIGS. 8 to 13, for example. For example, the first calculation unit 602 may update the first penalty stored in the first storage unit 600 with the first penalty calculated in the current time. Therefore, the management side apparatus 201 may obtain a guideline for reducing a difference between the first order quantity and the second order quantity and a difference between the first profit amount and the second profit amount.

For example, every time the first ratio and the second ratio are acquired, the first calculation unit 602 calculates the second penalty based on the first ratio and the second ratio which are acquired in the current time. For example, the first calculation unit 602 calculates the second penalty by adding a difference value obtained by subtracting the acquired second ratio from the acquired first ratio and an integral value of the difference value.

A specific example of calculating the second penalty will be described later with reference to FIGS. 8 to 13, for example. For example, the first calculation unit 602 may update the second penalty stored in the first storage unit 600 with the second penalty calculated in the current time. Therefore, the management side apparatus 201 may obtain a guideline for reducing a difference between the first ratio and the second ratio.

The first output unit 603 outputs a process result of at least any functional unit. The output is made in, for example, a form of display on a display, print output to a printer, transmission to an external apparatus through the network I/F 303, or storage in a storage region such as the memory 302 or the recording medium 305. Therefore, the first output unit 603 may notify the management side user of the process result of at least any functional unit, which may consequently improve the convenience of the management side apparatus 201.

For example, the first output unit 603 notifies the order receiving side to calculate the first order quantity and the first profit amount by using the first parameter including the calculated first penalty. For example, the first output unit 603 transmits a notification including the calculated first penalty to the order receiving side. Therefore, the first output unit 603 may enable the order receiving side to adjust the first order quantity and the first profit amount so that the difference between the first order quantity and the second order quantity and the difference between the first profit amount and the second profit amount are reduced.

For example, the first output unit 603 may notify the order receiving side to calculate the first order quantity, the first profit amount, and the first ratio by using the first parameter including the calculated first penalty and the calculated second penalty. For example, the first output unit 603 transmits a notification including the calculated first penalty and second penalty to the order receiving side. Therefore, the first output unit 603 may enable the order receiving side to adjust the first order quantity and the first profit amount so that the difference between the first order quantity and the second order quantity and the difference between the first profit amount and the second profit amount are reduced. The first output unit 603 may enable the order receiving side to adjust the first ratio so that the difference between the first ratio and the second ratio is reduced.

For example, the first output unit 603 notifies the ordering side to calculate the second order quantity and the second profit amount by using the second parameter including the calculated first penalty. For example, the first output unit 603 transmits a notification including the calculated first penalty to the ordering side. Therefore, the first output unit 603 may enable the ordering side to adjust the second order quantity and the second profit amount so that the difference between the first order quantity and the second order quantity and the difference between the first profit amount and the second profit amount are reduced.

For example, the first output unit 603 may notify the ordering side to calculate the second order quantity, the second profit amount, and the second ratio by using the second parameter including the calculated first penalty and the calculated second penalty. For example, the first output unit 603 transmits a notification including the calculated first penalty and second penalty to the ordering side. Therefore, the first output unit 603 may enable the ordering side to adjust the second order quantity and the second profit amount so that the difference between the first order quantity and the second order quantity and the difference between the first profit amount and the second profit amount are reduced. The first output unit 603 may enable the ordering side to adjust the second ratio so that the difference between the first ratio and the second ratio is reduced.

The order receiving side apparatus 202 includes a second storage unit 610, a second acquisition unit 611, a second calculation unit 612, and a second output unit 613.

The second storage unit 610 is implemented by, for example, a storage region such as the memory 402 or the recording medium 405 illustrated in FIG. 4. Hereinafter, a case where the second storage unit 610 is included in the order receiving side apparatus 202 will be described, and the embodiment is not limited thereto. For example, the second storage unit 610 is included in an apparatus different from the order receiving side apparatus 202, and contents stored in the second storage unit 610 may be referred to from the order receiving side apparatus 202, in some cases.

The second acquisition unit 611 to the second output unit 613 function as an example of a control unit. For example, the functions of the second acquisition unit 611 to the second output unit 613 are implemented by causing the CPU 401 to execute a program stored in the storage region such as the memory 402 or the recording medium 405 illustrated in FIG. 4 or by using the network I/F 403. A process result by each functional unit is stored in, for example, the storage region such as the memory 402 or the recording medium 405 illustrated in FIG. 4.

The second storage unit 610 stores various types of information to be referred to or updated in a process performed by each functional unit. For example, the second storage unit 610 stores first confidential information.

For example, the second storage unit 610 stores a first order quantity and a first profit amount. For example, the first order quantity and the first profit amount are calculated by the second calculation unit 612. For example, the second storage unit 610 stores a first ratio. For example, the first ratio is calculated by the second calculation unit 612.

The second storage unit 610 stores a first penalty. For example, the first penalty is acquired by the second acquisition unit 611. The second storage unit 610 stores a second penalty. For example, the second penalty is acquired by the second acquisition unit 611.

The second acquisition unit 611 acquires various types of information to be used in a process performed by each functional unit. The second acquisition unit 611 stores the acquired various types of information in the second storage unit 610, or outputs the acquired various types of information to each functional unit. The second acquisition unit 611 may output the various types of information stored in the second storage unit 610 to each functional unit. For example, the second acquisition unit 611 acquires various types of information based on an operation input by the order receiving side user. For example, the second acquisition unit 611 may receive the various types of information from an apparatus different from the order receiving side apparatus 202.

For example, the second acquisition unit 611 acquires the first penalty from the management side apparatus 201. For example, the second acquisition unit 611 acquires the first penalty by receiving a notification including the first penalty from the management side apparatus 201. Therefore, the second acquisition unit 611 may obtain a guideline for reducing a difference between the first order quantity and the second order quantity and a difference between the first profit amount and the second profit amount.

For example, the second acquisition unit 611 acquires the second penalty from the management side apparatus 201. For example, the second acquisition unit 611 acquires the second penalty by receiving a notification including the second penalty from the management side apparatus 201. Therefore, the second acquisition unit 611 may obtain a guideline for reducing a difference between the first ratio and the second ratio.

The second acquisition unit 611 may accept a start trigger for starting a process of any functional unit. For example, the start trigger is generated when a predetermined operation input is performed by an order receiving side user. The start trigger may be, for example, receipt of predetermined information from another computer. The start trigger may be, for example, an output of predetermined information by any functional unit. For example, the second acquisition unit 611 accepts the acquisition of the first penalty as a start trigger for starting a process of the second calculation unit 612. For example, the second acquisition unit 611 accepts the acquisition of the second penalty as a start trigger for starting the process of the second calculation unit 612.

For example, the second calculation unit 612 calculates the first order quantity and the first profit amount by using a first parameter including at least the first confidential information. For example, the second calculation unit 612 may calculate the first order quantity and the first profit amount by using the first parameter further including the acquired first penalty. For example, the second calculation unit 612 may calculate the first order quantity and the first profit amount by using the first parameter further including the acquired first penalty and second penalty.

A specific example of calculating the first order quantity and the first profit amount will be described later with reference to FIGS. 8 to 13, for example. Therefore, the second calculation unit 612 may enable the management side apparatus 201 to calculate the first penalty for appropriately adjusting the first order quantity and the first profit amount, without making the first confidential information public.

For example, the second calculation unit 612 calculates the first ratio by using the first parameter including at least the first confidential information. For example, the second calculation unit 612 may calculate the first ratio by using the first parameter further including the acquired first penalty. For example, the second calculation unit 612 may calculate the first ratio by using the first parameter further including the acquired first penalty and second penalty.

A specific example of calculating the first ratio will be described later with reference to FIGS. 8 to 13, for example. Therefore, the second calculation unit 612 may enable the management side apparatus 201 to calculate the first penalty for appropriately adjusting the first ratio, without making the first confidential information public.

The second output unit 613 outputs a process result of at least any functional unit. The output is made in, for example, a form of display on a display, print output to a printer, transmission to an external apparatus through the network I/F 403, or storage in a storage region such as the memory 402 or the recording medium 405. Therefore, the second output unit 613 may notify the order receiving side user of the process result of at least any functional unit, which may consequently improve the convenience of the order receiving side apparatus 202.

For example, the second output unit 613 transmits the calculated first order quantity and first profit amount to the management side apparatus 201. For example, every time the first order quantity and the first profit amount are calculated, the second output unit 613 transmits the calculated first order quantity and first profit amount to the management side apparatus 201. Therefore, the second output unit 613 may enable the management side apparatus 201 to calculate the first penalty.

For example, the second output unit 613 transmits the calculated first ratio to the management side apparatus 201. For example, every time the first ratio is calculated, the second output unit 613 transmits the calculated first ratio to the management side apparatus 201. Therefore, the second output unit 613 may enable the management side apparatus 201 to calculate the second penalty.

For example, the second output unit 613 may determine whether or not the first order quantity and the first profit amount converge. For example, in a case where the first penalty is a specific value indicating that the first order quantity and the second order quantity coincide with each other and the first profit amount and the second profit amount coincide with each other, the second output unit 613 determines that the convergence is made. For example, in a case where the first penalty is not the specific value, the second output unit 613 determines that the convergence is not made.

For example, in a case where the first order quantity and first profit amount calculated in the current time coincide with the first order quantity and first profit amount calculated in the previous time, the second output unit 613 may determine that the convergence is made. For example, in a case where the first order quantity and first profit amount calculated in the current time do not coincide with the first order quantity and first profit amount calculated in the previous time, the second output unit 613 may determine that the convergence is not made.

For example, in a case where it is determined that the convergence is made, the second output unit 613 outputs the first order quantity and the first profit amount so that the order receiving side user may refer to the first order quantity and the first profit amount. Therefore, the second output unit 613 enables the order receiving side user to refer to the first order quantity and the first profit amount for maximizing a profit of an entire supply chain.

The ordering side apparatus 203 includes a third storage unit 620, a third acquisition unit 621, a third calculation unit 622, and a third output unit 623.

The third storage unit 620 is implemented by, for example, a storage region such as the memory 502 or the recording medium 505 illustrated in FIG. 5. Hereinafter, a case where the third storage unit 620 is included in the ordering side apparatus 203 will be described, and the embodiment is not limited thereto. For example, the third storage unit 620 is included in an apparatus different from the ordering side apparatus 203, and contents stored in the third storage unit 620 may be referred to from the ordering side apparatus 203, in some cases.

The third acquisition unit 621 to the third output unit 623 function as an example of a control unit. For example, the functions of the third acquisition unit 621 to the third output unit 623 are implemented by causing the CPU 501 to execute a program stored in the storage region such as the memory 502 or the recording medium 505 illustrated in FIG. 5 or by using the network I/F 503. A process result by each functional unit is stored in the storage region such as the memory 502 or the recording medium 505 illustrated in FIG. 5, for example.

The third storage unit 620 stores various types of information to be referred to or updated in a process performed by each functional unit. For example, the third storage unit 620 stores second confidential information.

For example, the third storage unit 620 stores a second order quantity and a second profit amount. For example, the second order quantity and the second profit amount are calculated by the third calculation unit 622. For example, the third storage unit 620 stores a second ratio. For example, the second ratio is calculated by the third calculation unit 622.

The third storage unit 620 stores a first penalty. For example, the first penalty is acquired by the third acquisition unit 621. The third storage unit 620 stores a second penalty. For example, the second penalty is acquired by the third acquisition unit 621.

The third acquisition unit 621 acquires various types of information to be used in a process performed by each functional unit. The third acquisition unit 621 stores the acquired various types of information in the third storage unit 620, or outputs the acquired various types of information to each functional unit. The third acquisition unit 621 may output the various types of information stored in the third storage unit 620 to each functional unit. For example, the third acquisition unit 621 acquires various types of information based on an operation input by an ordering side user. For example, the third acquisition unit 621 may receive the various types of information from an apparatus different from the ordering side apparatus 203.

For example, the third acquisition unit 621 acquires the first penalty from the management side apparatus 201. For example, the third acquisition unit 621 acquires the first penalty by receiving a notification including the first penalty from the management side apparatus 201. Therefore, the third acquisition unit 621 may obtain a guideline for reducing a difference between the first order quantity and the second order quantity and a difference between the first profit amount and the second profit amount.

For example, the third acquisition unit 621 acquires the second penalty from the management side apparatus 201. For example, the third acquisition unit 621 acquires the second penalty by receiving a notification including the second penalty from the management side apparatus 201. Therefore, the third acquisition unit 621 may obtain a guideline for reducing a difference between the first ratio and the second ratio.

The third acquisition unit 621 may accept a start trigger for starting a process of any functional unit. For example, the start trigger is generated when a predetermined operation input is performed by the ordering side user. The start trigger may be, for example, receipt of predetermined information from another computer. The start trigger may be, for example, an output of predetermined information by any functional unit. For example, the third acquisition unit 621 accepts the acquisition of the first penalty as a start trigger for starting a process of the third calculation unit 622. For example, the third acquisition unit 621 accepts the acquisition of the second penalty as a start trigger for starting the process of the third calculation unit 622.

For example, the third calculation unit 622 calculates the second order quantity and the second profit amount by using a second parameter including at least the second confidential information. For example, the third calculation unit 622 may calculate the second order quantity and the second profit amount by using the second parameter further including the acquired first penalty. For example, the third calculation unit 622 may calculate the second order quantity and the second profit amount by using the second parameter further including the acquired first penalty and second penalty.

A specific example of calculating the second order quantity and the second profit amount will be described later with reference to FIGS. 8 to 13, for example. Therefore, the third calculation unit 622 may enable the management side apparatus 201 to calculate the first penalty for appropriately adjusting the second order quantity and the second profit amount, without making the second confidential information public.

For example, the third calculation unit 622 calculates the second ratio by using the second parameter including at least the second confidential information. For example, the third calculation unit 622 may calculate the second ratio by using the second parameter further including the acquired first penalty. For example, the third calculation unit 622 may calculate the second ratio by using a second parameter further including the acquired first penalty and second penalty.

A specific example of calculating the second ratio will be described later with reference to FIGS. 8 to 13, for example. Therefore, the third calculation unit 622 may enable the management side apparatus 201 to calculate the first penalty for appropriately adjusting the second ratio, without making the second confidential information public.

The third output unit 623 outputs a process result of at least any functional unit. The output is made in, for example, a form of display on a display, print output to a printer, transmission to an external apparatus through the network I/F 503, or storage in a storage region such as the memory 502 or the recording medium 505. Therefore, the third output unit 623 may notify the ordering side user of the process result in at least any functional unit, which may consequently improve the convenience of the ordering side apparatus 203.

For example, the third output unit 623 transmits the calculated second order quantity and second profit amount to the management side apparatus 201. For example, every time the second order quantity and the second profit amount are calculated, the third output unit 623 transmits the calculated second order quantity and second profit amount to the management side apparatus 201. Therefore, the third output unit 623 may enable the management side apparatus 201 to calculate the first penalty.

For example, the third output unit 623 transmits the calculated second ratio to the management side apparatus 201. For example, every time the second ratio is calculated, the third output unit 623 transmits the calculated second ratio to the management side apparatus 201. Therefore, the third output unit 623 may enable the management side apparatus 201 to calculate the second penalty.

For example, the third output unit 623 may determine whether or not the second order quantity and the second profit amount converge. For example, the third output unit 623 determines that the convergence is made in a case where the first penalty is a specific value indicating that the second order quantity and the second order quantity coincide with each other and the second profit amount and the second profit amount coincide with each other. For example, in a case where the first penalty is not the specific value, the third output unit 623 determines that the convergence is not made.

For example, the third output unit 623 may determine that the convergence is made in a case where the second order quantity and the second profit amount calculated in the current time coincide with the second order quantity and the second profit amount calculated in the previous time. For example, in a case where the second order quantity and the second profit amount calculated in the current time do not coincide with the second order quantity and the second profit amount calculated in the previous time, the third output unit 623 may determine that the convergence is not made.

For example, in a case where it is determined that the convergence is made, the third output unit 623 outputs the second order quantity and the second profit amount so that the ordering side user may refer to the second order quantity and the second profit amount. Therefore, the third output unit 623 enables the ordering side user to refer to the second order quantity and the second profit amount for maximizing a profit of an entire supply chain.

### Specific Example of Functional Configuration of Information Processing System 200

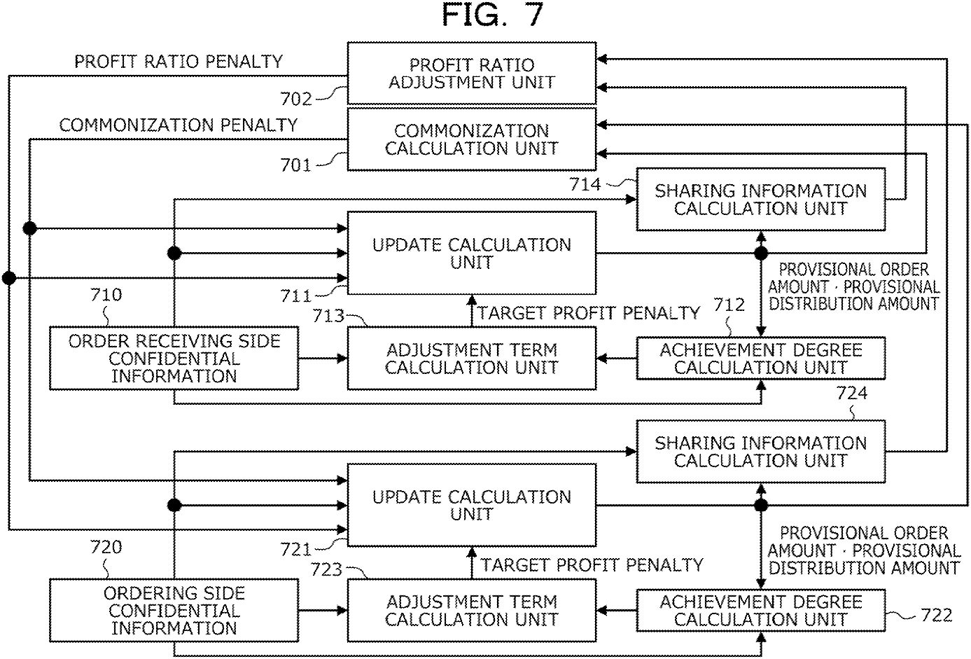

Next, a specific example of the functional configuration of the information processing system 200 will be described with reference to FIG. 7.

FIG. 7 is a block diagram illustrating the specific example of the functional configuration of the information processing system 200. As illustrated in FIG. 7, the management side apparatus 201 includes a commonization calculation unit 701 and a profit ratio adjustment unit 702.

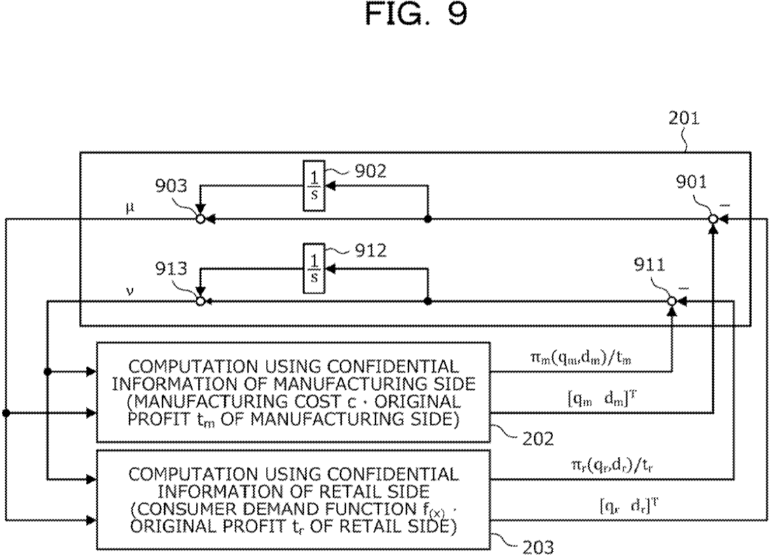

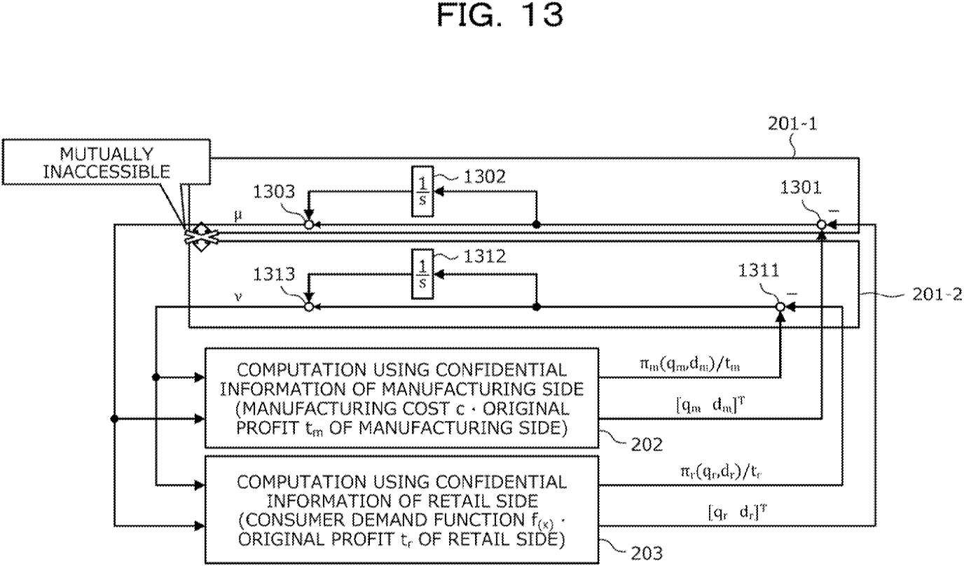

For example, the commonization calculation unit 701 receives a provisional order amount and a provisional distribution amount of an order receiving side from an update calculation unit 711 of the order receiving side. For example, the commonization calculation unit 701 receives a provisional order amount of an ordering side and a provisional distribution amount of the ordering side from an update calculation unit 721 of the ordering side. For example, the commonization calculation unit 701 calculates a commonization penalty, based on the provisional order amount of the order receiving side, the provisional distribution amount of the order receiving side, the provisional order amount of the ordering side, and the provisional distribution amount of the ordering side. For example, the commonization calculation unit 701 transmits the calculated commonization penalty to the update calculation unit 711 and the update calculation unit 721. For example, the commonization calculation unit 701 is implemented by computation units 901 to 903, which will be described later in FIG. 9 or computation units 1301 to 1303, which will be described later in FIG. 13.

For example, the profit ratio adjustment unit 702 receives sharing information of the order receiving side from a sharing information calculation unit 714. For example, the profit ratio adjustment unit 702 receives sharing information of the ordering side from a sharing information calculation unit 724. For example, the profit ratio adjustment unit 702 calculates a profit ratio penalty, based on the acquired sharing information of the order receiving side and sharing information of the ordering side. For example, the profit ratio adjustment unit 702 transmits the calculated profit ratio penalty to the update calculation unit 711 and the update calculation unit 721. For example, the profit ratio adjustment unit 702 is implemented by computation units 911 to 913, which will be described later in FIG. 9 or computation units 1311 to 1313, which will be described later in FIG. 13.

As illustrated in FIG. 7, the order receiving side apparatus 202 includes order receiving side confidential information 710. The order receiving side apparatus 202 includes the update calculation unit 711, an achievement degree calculation unit 712, an adjustment term calculation unit 713, and the sharing information calculation unit 714.

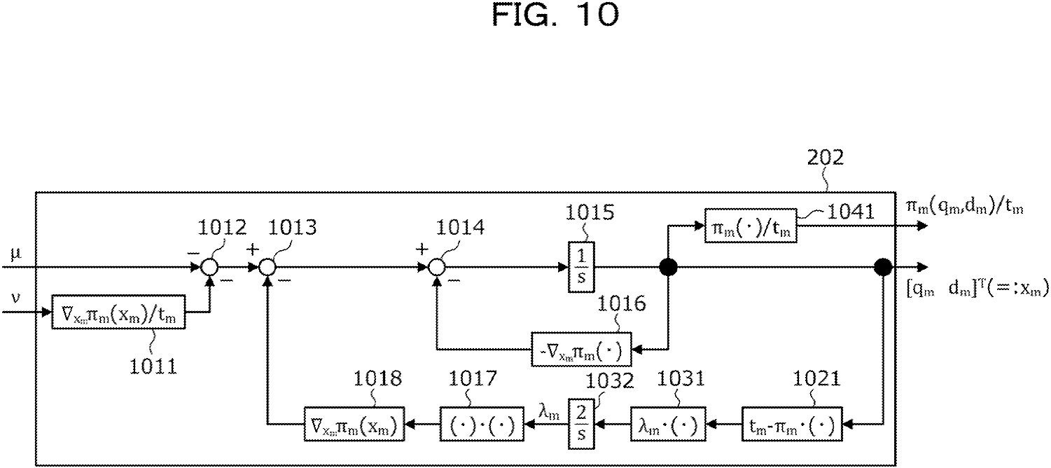

For example, the update calculation unit 711 reads the order receiving side confidential information 710. For example, the update calculation unit 711 receives the commonization penalty from the commonization calculation unit 701. For example, the update calculation unit 711 receives the profit ratio penalty from the profit ratio adjustment unit 702. For example, the update calculation unit 711 receives a target profit penalty from the adjustment term calculation unit 713. For example, the update calculation unit 711 calculates the provisional order amount of the order receiving side and the provisional distribution amount of the order receiving side, based on the order receiving side confidential information 710, the commonization penalty, the profit ratio penalty, and the target profit penalty. For example, the update calculation unit 711 transmits the calculated provisional order amount of the order receiving side and the calculated provisional distribution amount of the order receiving side to the commonization calculation unit 701, the achievement degree calculation unit 712, and the sharing information calculation unit 714. For example, the update calculation unit 711 is implemented by computation units 1011 to 1018, which will be described later in FIG. 10.

For example, the achievement degree calculation unit 712 reads the order receiving side confidential information 710. For example, the achievement degree calculation unit 712 receives the provisional order amount of the order receiving side and the provisional distribution amount of the order receiving side from the update calculation unit 711. For example, the achievement degree calculation unit 712 calculates a target profit achievement degree, based on the order receiving side confidential information 710, the provisional order amount of the order receiving side, and the provisional distribution amount of the order receiving side. For example, the achievement degree calculation unit 712 transmits the calculated target profit achievement degree to the adjustment term calculation unit 713. For example, the achievement degree calculation unit 712 is implemented by a computation unit 1021, which will be described later in FIG. 10.

For example, the adjustment term calculation unit 713 reads the order receiving side confidential information 710. For example, the adjustment term calculation unit 713 receives the target profit achievement degree from the achievement degree calculation unit 712. For example, the adjustment term calculation unit 713 calculates the target profit penalty, based on the order receiving side confidential information 710 and the target profit achievement degree. For example, the adjustment term calculation unit 713 transmits the calculated target profit penalty to the update calculation unit 711. For example, the adjustment term calculation unit 713 is implemented by computation units 1031 and 1032, which will be described later in FIG. 10.

For example, the sharing information calculation unit 714 reads the order receiving side confidential information 710. For example, the sharing information calculation unit 714 receives the provisional order amount of the order receiving side and the provisional distribution amount of the order receiving side from the update calculation unit 711. For example, the sharing information calculation unit 714 calculates the sharing information of the order receiving side, based on the order receiving side confidential information 710, the provisional order amount of the order receiving side, and the provisional distribution amount of the order receiving side. For example, the sharing information calculation unit 714 transmits the calculated sharing information of the order receiving side to the profit ratio adjustment unit 702. For example, the sharing information calculation unit 714 is implemented by a computation unit 1041, which will be described later in FIG. 10.

As illustrated in FIG. 7, the ordering side apparatus 203 includes ordering side confidential information 720. An ordering side apparatus 203 includes the update calculation unit 721, an achievement degree calculation unit 722, an adjustment term calculation unit 723, and the sharing information calculation unit 724.

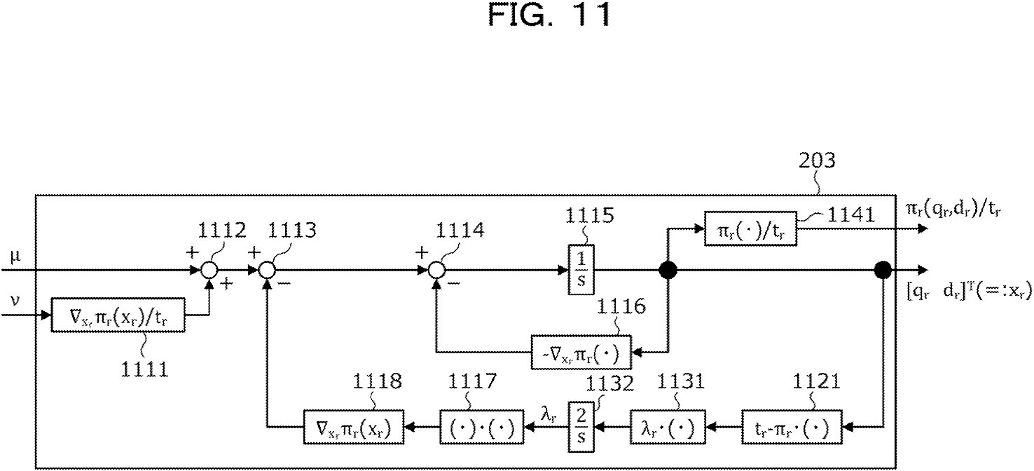

For example, the update calculation unit 721 reads the ordering side confidential information 720. For example, the update calculation unit 721 receives the commonization penalty from the commonization calculation unit 701. For example, the update calculation unit 721 receives the profit ratio penalty from the profit ratio adjustment unit 702. For example, the update calculation unit 721 receives the target profit penalty from the adjustment term calculation unit 723. For example, the update calculation unit 721 calculates the provisional order amount of the ordering side and the provisional distribution amount of the ordering side, based on the ordering side confidential information 720, the commonization penalty, the profit ratio penalty, and the target profit penalty. For example, the update calculation unit 721 transmits the calculated provisional order amount of the ordering side and the calculated provisional distribution amount of the ordering side to the commonization calculation unit 701, the achievement degree calculation unit 722, and the sharing information calculation unit 724. For example, the update calculation unit 721 is implemented by computation units 1111 to 1118, which will be described later in FIG. 11.

For example, the achievement degree calculation unit 722 reads the ordering side confidential information 720. For example, the achievement degree calculation unit 722 receives the provisional order amount of the ordering side and the provisional distribution amount of the ordering side from the update calculation unit 721. For example, the achievement degree calculation unit 722 calculates a target profit achievement degree, based on the ordering side confidential information 720, the provisional order amount of the ordering side, and the provisional distribution amount of the ordering side. For example, the achievement degree calculation unit 722 transmits the calculated target profit achievement degree to the adjustment term calculation unit 723. For example, the achievement degree calculation unit 722 is implemented by a computation unit 1121, which will be described later in FIG. 11.

For example, the adjustment term calculation unit 723 reads the ordering side confidential information 720. For example, the adjustment term calculation unit 723 receives the target profit achievement degree from the achievement degree calculation unit 722. For example, the adjustment term calculation unit 723 calculates a target profit penalty, based on the ordering side confidential information 720 and the target profit achievement degree. For example, the adjustment term calculation unit 723 transmits the calculated target profit penalty to the update calculation unit 721. For example, the adjustment term calculation unit 723 is implemented by computation units 1131 and 1132, which will be described later in FIG. 11.

For example, the sharing information calculation unit 724 reads the ordering side confidential information 720. For example, the sharing information calculation unit 724 receives the provisional order amount of the ordering side and the provisional distribution amount of the ordering side from the update calculation unit 721. For example, the sharing information calculation unit 724 calculates sharing information of the ordering side, based on the ordering side confidential information 720, the provisional order amount of the ordering side, and the provisional distribution amount of the ordering side. For example, the sharing information calculation unit 724 transmits the calculated sharing information of the ordering side to the profit ratio adjustment unit 702. For example, the sharing information calculation unit 724 is implemented by a computation unit 1141, which will be described later in FIG. 11.

### First Operation Example of Information Processing System 200

A first operation example of the information processing system 200 will be described with reference to FIGS. 8 to 11.

FIG. 8 to FIG. 11 are explanatory diagrams illustrating the first operation example of the information processing system 200. As illustrated in FIG. 8, the information processing system 200 is applied to a supply chain in which a retailer as an ordering side purchases a product from a manufacturer as an order receiving side, and the retailer as the ordering side sells the product to a consumer.

In the example illustrated in FIG. 8, there are the order receiving side apparatus 202 owned by the manufacturer, the ordering side apparatus 203 owned by the retailer, and the management side apparatus 201 belonging to neither the manufacturer nor the retailer.

The order receiving side apparatus 202 acquires confidential information of the manufacturing side, based on an operation input of a manufacturing side user. The confidential information of the manufacturing side includes a manufacturing cost of a product, a provisional profit of the manufacturing side, and the like. The order receiving side apparatus 202 stores a commonization penalty and a profit ratio penalty. The commonization penalty and the profit ratio penalty are initialized as predetermined values. For example, the predetermined value is 0.

Every time the commonization penalty is received from the management side apparatus 201, the order receiving side apparatus 202 updates the stored commonization penalty with the received commonization penalty. Every time the profit ratio penalty is received from the management side apparatus 201, the order receiving side apparatus 202 updates the stored profit ratio penalty with the received profit ratio penalty.

Based on the confidential information of the manufacturing side, the commonization penalty, and the profit ratio penalty, the order receiving side apparatus 202 calculates a provisional order amount of the manufacturing side, a provisional distribution amount of the manufacturing side, and sharing information of a profit ratio of the manufacturing side. The provisional order amount of the manufacturing side indicates an order amount of a product ordered from the retail side to the manufacturing side, which is provisionally determined by the manufacturing side. The provisional distribution amount of the manufacturing side indicates a profit amount to be distributed from the manufacturing side to the retail side, which is provisionally determined by the manufacturing side. The sharing information of the profit ratio of the manufacturing side indicates a profit ratio of the provisional profit of the manufacturing side to an original profit of the manufacturing side.

Until the provisional order amount of the manufacturing side, the provisional distribution amount of the manufacturing side, and the profit ratio of the manufacturing side converge, the order receiving side apparatus 202 may recalculate the provisional order amount of the manufacturing side, the provisional distribution amount of the manufacturing side, and the sharing information of the profit ratio of the manufacturing side every time the commonization penalty and the profit ratio penalty are updated. The order receiving side apparatus 202 transmits the calculated provisional order amount of the manufacturing side, the calculated provisional distribution amount of the manufacturing side, and the calculated sharing information of the profit ratio of the manufacturing side to the management side apparatus 201 via the network 210.

The ordering side apparatus 203 acquires confidential information of the retail side, based on an operation input of a retail side user. The confidential information of the retail side includes demand information of the consumer for the product, a provisional profit of the retail side, and the like. For example, the demand information includes a probability distribution indicating the demand of the consumer. The ordering side apparatus 203 stores a commonization penalty and a profit ratio penalty. The commonization penalty and the profit ratio penalty are initialized as predetermined values. For example, the predetermined value is 0.

Every time the commonization penalty is received from the management side apparatus 201, the ordering side apparatus 203 updates the stored commonization penalty with the received commonization penalty. Every time the profit ratio penalty is received from the management side apparatus 201, the ordering side apparatus 203 updates the stored profit ratio penalty with the received profit ratio penalty.

Based on the confidential information of the retail side, the commonization penalty, and the profit ratio penalty, the ordering side apparatus 203 calculates a provisional order amount of the retail side, a provisional distribution amount of the retail side, and sharing information of a profit ratio of the retail side. The provisional order amount of the retail side indicates an order amount of a product ordered from the retail side to the manufacturing side, which is provisionally determined by the retail side. The provisional distribution amount of the retail side indicates a profit amount to be distributed from the manufacturing side to the retail side, which is provisionally determined by the retail side. The sharing information of the profit ratio of the retail side indicates a profit ratio of the provisional profit of the retail side to an original profit of the retail side.

Until the provisional order amount of the retail side, the provisional distribution amount of the retail side, and the profit ratio of the retail side converge, the ordering side apparatus 203 may recalculate the provisional order amount of the retail side, the provisional distribution amount of the retail side, and the sharing information of the profit ratio of the retail side every time the commonization penalty and the profit ratio penalty are updated. The ordering side apparatus 203 transmits the calculated provisional order amount of the retail side, the calculated provisional distribution amount of the retail side, and the calculated sharing information of the profit ratio of the retail side to the management side apparatus 201 via the network 210.

The management side apparatus 201 receives the provisional order amount of the manufacturing side and the provisional distribution amount of the manufacturing side from the order receiving side apparatus 202 via the network 210. The management side apparatus 201 receives the provisional order amount of the retail side and the provisional distribution amount of the retail side from the ordering side apparatus 203 via the network 210.

Every time the provisional order amount of the manufacturing side, the provisional distribution amount of the manufacturing side, the provisional order amount of the retail side, and the provisional distribution amount of the retail side are received, the management side apparatus 201 calculates a commonization penalty. For example, the management side apparatus 201 calculates the commonization penalty, based on the provisional order amount of the manufacturing side, the provisional distribution amount of the manufacturing side, the provisional order amount of the retail side, and the provisional distribution amount of the retail side.

By transmitting the calculated commonization penalty to the order receiving side apparatus 202, the management side apparatus 201 updates the commonization penalty stored in the order receiving side apparatus 202. By transmitting the calculated commonization penalty to the ordering side apparatus 203, the management side apparatus 201 updates the commonization penalty stored in the ordering side apparatus 203.

The management side apparatus 201 receives the sharing information of the profit ratio of the manufacturing side from the order receiving side apparatus 202 via the network 210. The sharing information of the profit ratio of the retail side is received from the ordering side apparatus 203 via the network 210.

Every time the sharing information of the profit ratio of the manufacturing side and the sharing information of the profit ratio of the retail side are received, the management side apparatus 201 calculates a profit ratio penalty, based on the sharing information of the profit ratio of the manufacturing side and the sharing information of the profit ratio of the retail side.

By transmitting the calculated profit ratio penalty to the order receiving side apparatus 202, the management side apparatus 201 updates the profit ratio penalty stored in the order receiving side apparatus 202. By transmitting the calculated profit ratio penalty to the ordering side apparatus 203, the management side apparatus 201 updates the profit ratio penalty stored in the ordering side apparatus 203. Next, the description continues with reference to FIG. 9, and a specific example of computation by the management side apparatus 201 will be described.

As illustrated in FIG. 9, the order receiving side apparatus 202 has confidential information of the manufacturing side. For example, the confidential information of the manufacturing side includes a manufacturing cost c and an original profit tₘ of the manufacturing side. The order receiving side apparatus 202 has the commonization penalty µ and the profit ratio penalty v.

Based on the confidential information of the manufacturing side, the commonization penalty µ, and the profit ratio penalty v, the order receiving side apparatus 202 calculates a provisional order amount qₘ of the manufacturing side and a provisional distribution amount dₘ of the manufacturing side. Based on the confidential information of the manufacturing side, the provisional order amount qₘ of the manufacturing side, and the provisional distribution amount dₘ of the manufacturing side, the order receiving side apparatus 202 calculates a profit ratio πₘ(qₘ, dₘ)/tₘ of the provisional profit πₘ(qₘ, dₘ) to the original profit tₘ of the manufacturing side.

The order receiving side apparatus 202 transmits a matrix [qₘ dₘ]^{T} including the calculated provisional order amount qₘ of the manufacturing side and the provisional distribution amount dₘ of the manufacturing side to the management side apparatus 201. The order receiving side apparatus 202 transmits the calculated profit ratio πₘ(qₘ, dₘ)/tₘ of the manufacturing side to the management side apparatus 201. A specific example of computation by the order receiving side apparatus 202 will be described later with reference to, for example, FIG. 10.

As illustrated in FIG. 9, the ordering side apparatus 203 has confidential information of the retail side. For example, the confidential information of the retail side includes a consumer demand function f₍ₓ₎ and the original profit tᵣ of the retail side. The ordering side apparatus 203 has the commonization penalty µ and the profit ratio penalty v.

Based on the confidential information of the retail side, the commonization penalty µ, and the profit ratio penalty v, the ordering side apparatus 203 calculates a provisional order amount qᵣ of the retail side and a provisional distribution amount dᵣ of the retail side. The ordering side apparatus 203 calculates a profit ratio πᵣ(qᵣ, dᵣ)/tᵣ of the provisional profit πᵣ(qᵣ, dᵣ) to the original profit tᵣ of the retail side, based on confidential information of the retail side, a provisional order amount qᵣ of the retail side, and the provisional distribution amount dᵣ of the retail side.

The ordering side apparatus 203 transmits a matrix [qᵣ dᵣ]^{T} including the calculated provisional order amount of the retail side qᵣ and the calculated provisional distribution amount of the retail side dᵣ to the management side apparatus 201. The ordering side apparatus 203 transmits the calculated profit ratio πᵣ(qᵣ, dᵣ)/tᵣ of the retail side to the management side apparatus 201. A specific example of computation by the ordering side apparatus 203 will be described later with reference to, for example, FIG. 11.

As illustrated in FIG. 9, the management side apparatus 201 includes the computation units 901 to 903. The management side apparatus 201 receives the matrix [qₘ dₘ]^{T} of the manufacturing side from the order receiving side apparatus 202. A management side apparatus 201 receives the matrix [qᵣ dᵣ]^{T} of the retail side from the ordering side apparatus 203.

The computation unit 901 calculates a difference obtained by subtracting the matrix [qᵣ dᵣ]^{T} of the retail side from the matrix [qₘ dₘ]^{T} of the manufacturing side, and transmits the difference to the computation units 902 and 903. The computation unit 902 receives the difference, calculates an integral value of the received difference, and transmits the integral value to the computation unit 903. By adding the difference and the integral value, the computation unit 903 calculates the commonization penalty µ. The management side apparatus 201 transmits the commonization penalty µ to the order receiving side apparatus 202 and the ordering side apparatus 203.

As illustrated in FIG. 9, the management side apparatus 201 includes the computation units 911 to 913. The management side apparatus 201 receives the profit ratio πₘ(qₘ, dₘ)/tₘ of the manufacturing side from the order receiving side apparatus 202. The management side apparatus 201 receives the profit ratio πᵣ(qᵣ, dᵣ)/tᵣ of the retail side from the ordering side apparatus 203.

The computation unit 911 calculates a difference obtained by subtracting the profit ratio πᵣ(qᵣ, dᵣ)/tᵣ of the retail side from the profit ratio πₘ(qₘ, dₘ)/tₘ of the manufacturing side, and transmits the difference to the computation units 912 and 913. The computation unit 912 receives the difference, calculates an integral value of the received difference, and transmits the integral value to the computation unit 913. By adding the difference and the integral value, the computation unit 913 calculates the profit ratio penalty v. The management side apparatus 201 transmits the profit ratio penalty v to the order receiving side apparatus 202 and the ordering side apparatus 203.

Therefore, the management side apparatus 201 may cause the manufacturing side to adjust the provisional order amount qₘ of the manufacturing side and may cause the retail side to adjust the provisional order amount qᵣ of the retail side so that the provisional order amount qₘ of the manufacturing side and the provisional order amount qᵣ of the retail side coincide with each other. The management side apparatus 201 may cause the manufacturing side to adjust the provisional distribution amount dₘ of the manufacturing side and cause the retail side to adjust the provisional distribution amount dᵣ of the retail side so that the provisional distribution amount dₘ of the manufacturing side and the provisional distribution amount dᵣ of the retail side coincide with each other. The management side apparatus 201 may maximize a profit of the entire supply chain.

The management side apparatus 201 may cause the manufacturing side to adjust the provisional profit πₘ(qₘ, dₘ) of the manufacturing side so that the profit ratio πₘ(qₘ, dₘ)/tₘ of the manufacturing side and the profit ratio πᵣ(qᵣ, dᵣ)/tᵣ of the retail side coincide with each other. The management side apparatus 201 may cause the retail side to adjust the provisional profit πᵣ(qᵣ, dᵣ) of the retail side so that the profit ratio πₘ(qₘ, dₘ)/tₘ of the manufacturing side and the profit ratio πᵣ(qᵣ, dᵣ)/tᵣ of the retail side coincide with each other. For maximizing the profit of the entire supply chain, the management side apparatus 201 may enable the manufacturing side and the retail side to fairly maximize the profits. Next, the description continues with reference to FIG. 10, and a specific example of computation of the order receiving side apparatus 202 will be described.

As illustrated in FIG. 10, the order receiving side apparatus 202 includes the computation units 1011 to 1018, the computation unit 1021, the computation units 1031 and 1032, and the computation unit 1041. The order receiving side apparatus 202 stores confidential information of the manufacturing side including the manufacturing cost c and the original profit tₘ of the manufacturing side. The order receiving side apparatus 202 receives the commonization penalty µ from the management side apparatus 201. The order receiving side apparatus 202 receives the profit ratio penalty v from the management side apparatus 201.

The computation unit 1011 accepts the profit ratio penalty v as an input. The computation unit 1011 transmits a value obtained by multiplying the profit ratio penalty v, which is the input, by a value of the following equation (1) to the computation unit 1012, as an output.

$${∇}_{{X}_{m}} {π}_{m} \left({x}_{m}\right) / {t}_{m}$$

.

The computation unit 1012 accepts the commonization penalty µ and the output of the computation unit 1011 as inputs. The computation unit 1012 transmits a value obtained by making each value, which is the input, negative and adding up each value to the computation unit 1013 as an output.

The computation unit 1013 accepts the output of the computation unit 1012 and an output of the computation unit 1018 as inputs. The output of the computation unit 1018 will be described later. The computation unit 1013 transmits a value obtained by subtracting the output of the computation unit 1018, which is the input, from the output of the computation unit 1012, which is the input, to the computation unit 1014 as an output.

The computation unit 1014 accepts the output of the computation unit 1013 and an output of the computation unit 1016 as inputs. The output of the computation unit 1016 will be described later. The computation unit 1014 transmits a value obtained by subtracting the output of the computation unit 1016, which is the input, from the output of the computation unit 1013, which is the input, to the computation unit 1015 as an output.

The computation unit 1015 accepts the output of the computation unit 1014 as an input. The computation unit 1015 transmits a value obtained by integrating the output of the computation unit 1014, which is the input, to the computation unit 1016, the computation unit 1021, and the computation unit 1041 as outputs. The order receiving side apparatus 202 transmits the output of the computation unit 1015 to the management side apparatus 201 as the matrix [qₘ dₘ]^{T} including the provisional order amount qₘ of the manufacturing side and the provisional distribution amount dₘ of the manufacturing side.

The computation unit 1016 accepts the output of the computation unit 1015 as an input. The computation unit 1016 transmits, as an output, a value obtained by substituting the output of the computation unit 1015, which is the input, into (▪) in the following equation (2) to the computation unit 1014.

$$- {∇}_{{x}_{m}} {π}_{m} \left(⋅\right)$$

The computation unit 1021 accepts the output of the computation unit 1015 as an input. The computation unit 1021 transmits, as an output, a value obtained by substituting the output of the computation unit 1015, which is the input, into (▪) of the following equation (3), to the computation unit 1031.

$${t}_{m} - {π}_{m} . \left(⋅\right)$$

The computation unit 1031 accepts the output of the computation unit 1021 as an input. The computation unit 1031 transmits, as an output, a value obtained by substituting the output of the computation unit 1021, which is the input, into (▪) of the following equation (4), to the computation unit 1032.

$${λ}_{m} ⋅ \left(⋅\right)$$

The computation unit 1032 accepts the output of the computation unit 1031 as an input. The computation unit 1032 transmits a target profit penalty λₘ obtained by integrating and doubling the output of the computation unit 1031 to the computation unit 1017 as an output.

The computation unit 1017 accepts the output of the computation unit 1032 as an input. The computation unit 1017 transmits, as an output, a value obtained by substituting the output of the computation unit 1032, which is the input, into (▪) of the following equation (5), to the computation unit 1018.

$$\left(⋅\right) ⋅ \left(⋅\right)$$

The computation unit 1018 accepts the output of the computation unit 1017 as an input. The computation unit 1018 transmits a value obtained by multiplying a value of the following equation (6) by the output of the computation unit 1017, which is the input, to the computation unit 1013 as an output.

$${∇}_{{x}_{m}} {π}_{m} \left({x}_{m}\right)$$

The computation unit 1041 accepts the output of the computation unit 1015 as an input. The computation unit 1041 outputs a value obtained by substituting the output of the computation unit 1015, which is the input, into (▪) of the following equation (7). The order receiving side apparatus 202 transmits the output of the computation unit 1041 as the profit ratio ⊓ₘ(qₘ, dₘ)/tₘ of the manufacturing side to the management side apparatus 201.

$${π}_{m} \left(⋅\right) / {t}_{m}$$

Therefore, the order receiving side apparatus 202 may adjust the provisional profit ⊓ₘ(qₘ, dₘ) of the manufacturing side within a range in which the profit ratio ⊓ₘ(qₘ, dₘ)/tₘ of the manufacturing side and the profit ratio ⊓ᵣ(qᵣ, dᵣ)/tᵣ of the retail side coincide with each other. Since the order receiving side apparatus 202 does not have to make the confidential information of the manufacturing side public, security may be ensured, and the manufacturing side may be unlikely to suffer from disadvantages. Next, the description continues with reference to FIG. 11, and a specific example of computation of the ordering side apparatus 203 will be described.

As illustrated in FIG. 11, the ordering side apparatus 203 includes the computation units 1111 to 1118, the computation unit 1121, the computation units 1131 and 1132, and the computation unit 1141. The ordering side apparatus 203 stores confidential information of the retail side including the consumer demand function f(ₓ) and the original profit tᵣ of the retail side. The ordering side apparatus 203 receives the commonization penalty µ from the management side apparatus 201. The ordering side apparatus 203 receives the profit ratio penalty v from the management side apparatus 201.

The computation unit 1111 accepts the profit ratio penalty v as an input. The computation unit 1111 transmits a value obtained by multiplying the profit ratio penalty v, which is the input, by a value of the following equation (8) to the computation unit 1112, as an output.

$${∇}_{{x}_{r}} {π}_{r} \left({x}_{r}\right) / {t}_{r}$$

The computation unit 1112 accepts the commonization penalty µ and the output of the computation unit 1111 as inputs. The computation unit 1112 transmits a value obtained by adding up each value which is the input to the computation unit 1113 as an output.

The computation unit 1113 accepts the output of the computation unit 1112 and an output of the computation unit 1118 as inputs. The output of the computation unit 1118 will be described later. The computation unit 1113 transmits a value obtained by subtracting the output of the computation unit 1118, which is the input, from the output of the computation unit 1112, which is the input, to the computation unit 1114 as an output.

The computation unit 1114 accepts the output of the computation unit 1113 and an output of the computation unit 1116 as inputs. The output of the computation unit 1116 will be described later. The computation unit 1114 transmits a value obtained by subtracting the output of the computation unit 1116, which is the input, from the output of the computation unit 1113, which is the input, to the computation unit 1115 as an output.

The computation unit 1115 accepts the output of the computation unit 1114 as an input. The computation unit 1115 transmits a value obtained by integrating the output of the computation unit 1114, which is the input, to the computation unit 1161, the computation unit 1121, and the computation unit 1141 as outputs. The ordering side apparatus 203 transmits the output of the computation unit 1115 to the management side apparatus 201 as the matrix [qᵣ dᵣ]^{T} including the provisional order amount qᵣ of the retail side and the provisional distribution amount dᵣ of the retail side.

The computation unit 1116 accepts the output of the computation unit 1115 as an input. The computation unit 1116 transmits, as an output, a value obtained by substituting the output of the computation unit 1115, which is the input, into (▪) in the following equation (9) to the computation unit 1114.

$$- {∇}_{{x}_{r}} {π}_{r} \left(⋅\right)$$

The computation unit 1121 accepts the output of the computation unit 1115 as an input. The computation unit 1121 transmits, as an output, a value obtained by substituting the output of the computation unit 1115, which is the input, into (▪) of the following equation (10), to the computation unit 1131.

$${t}_{r} - {π}_{r} ⋅ \left(⋅\right)$$

The computation unit 1131 accepts the output of the computation unit 1121 as an input. The computation unit 1131 transmits, as an output, a value obtained by substituting the output of the computation unit 1121, which is the input, into (▪) of the following equation (11), to the computation unit 1132.

$${λ}_{r} ⋅ \left(⋅\right)$$

The computation unit 1132 accepts the output of the computation unit 1131 as an input. The computation unit 1132 transmits a target profit penalty λᵣ obtained by integrating and doubling the output of the computation unit 1131 to the computation unit 1117 as an output.

The computation unit 1117 accepts the output of the computation unit 1132 as an input. The computation unit 1117 transmits, as an output, a value obtained by substituting the output of the computation unit 1132, which is the input, into (▪) of the following equation (12), to the computation unit 1118.

$$\left(⋅\right) ⋅ \left(⋅\right)$$

The computation unit 1118 accepts the output of the computation unit 1117 as an input. The computation unit 1118 transmits a value obtained by multiplying a value of the following equation (13) by the output of the computation unit 1117, which is the input, to the computation unit 1113 as an output.

$${∇}_{{x}_{r}} {π}_{r} \left({x}_{r}\right)$$

The computation unit 1141 accepts the output of the computation unit 1115 as an input. The computation unit 1141 outputs a value obtained by substituting the output of the computation unit 1115, which is the input, into (▪) of the following equation (14). The ordering side apparatus 203 transmits the output of the computation unit 1141 as the profit ratio ⊓ᵣ(qᵣ, dᵣ)/tᵣ of the retail side to the management side apparatus 201.

$${π}_{r} \left(⋅\right) / {t}_{r}$$

Therefore, the ordering side apparatus 203 may adjust the provisional profit ⊓ᵣ(qᵣ, dᵣ) of the retail side within a range in which the profit ratio ⊓ₘ(qₘ, dₘ)/tₘ of the manufacturing side and the profit ratio ⊓ᵣ(qᵣ, dᵣ)/tᵣ of the retail side coincide with each other. Since the ordering side apparatus 203 does not have to make the confidential information of the retail side public, security may be ensured, and the retail side may be unlikely to suffer from disadvantages. In this manner, the information processing system 200 may maximize the profit of the entire supply chain even when the retail side and the manufacturing side do not make the confidential information public.

### Second Operation Example of Information Processing System 200

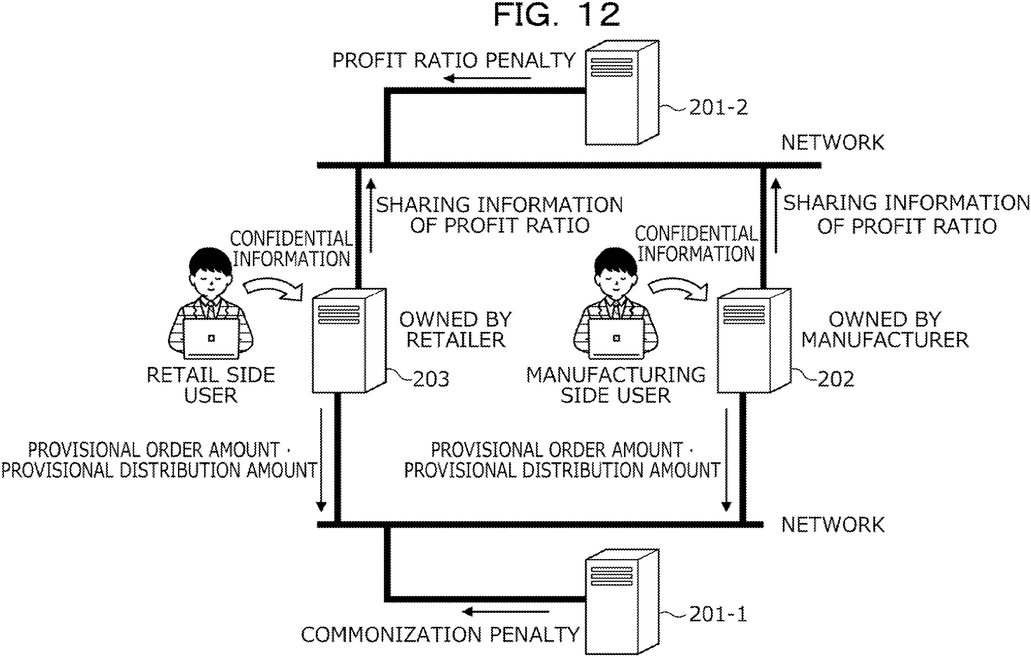

Next, a second operation example of the information processing system 200 will be described with reference to FIGS. 12 and 13. The first operation example is an operation example corresponding to a case where the information processing system 200 includes one management side apparatus 201. By contrast, the second operation example is an operation example corresponding to a case where the information processing system 200 includes two management side apparatuses 201.

FIG. 12 and FIG. 13 are explanatory diagrams illustrating the second operation example of the information processing system 200. As illustrated in FIG. 12, the information processing system 200 is applied to a supply chain in which a retailer as an ordering side purchases a product from a manufacturer as an order receiving side, and the retailer as the ordering side sells the product to a consumer.

In the example illustrated in FIG. 12, there are the order receiving side apparatus 202 owned by the manufacturer, the ordering side apparatus 203 owned by the retailer, and the two management side apparatuses 201 belonging to neither the manufacturer nor the retailer. For example, it is preferable that the two management side apparatuses 201 may not access each other. For example, it is preferable that the two management side apparatuses 201 belong to business entities different from each other. In the following description and drawings, the two management side apparatuses 201 are referred to as a “management side apparatus 201-1” and a “management side apparatus 201-2” so as to be distinguished from each other, in some cases.

The order receiving side apparatus 202 acquires confidential information of the manufacturing side, based on an operation input of a manufacturing side user. The confidential information of the manufacturing side includes a manufacturing cost of a product, a provisional profit of the manufacturing side, and the like. The order receiving side apparatus 202 stores a commonization penalty and a profit ratio penalty. The commonization penalty and the profit ratio penalty are initialized as predetermined values. For example, the predetermined value is 0.

Every time the commonization penalty is received from the management side apparatus 201-1, the order receiving side apparatus 202 updates the stored commonization penalty with the received commonization penalty. Every time the profit ratio penalty is received from the management side apparatus 201-2, the order receiving side apparatus 202 updates the stored profit ratio penalty with the received profit ratio penalty.

Based on the confidential information of the manufacturing side, the commonization penalty, and the profit ratio penalty, the order receiving side apparatus 202 calculates a provisional order amount of the manufacturing side, a provisional distribution amount of the manufacturing side, and sharing information of a profit ratio of the manufacturing side. The provisional order amount of the manufacturing side indicates an order amount of a product ordered from the retail side to the manufacturing side, which is provisionally determined by the manufacturing side. The provisional distribution amount of the manufacturing side indicates a profit amount to be distributed from the manufacturing side to the retail side, which is provisionally determined by the manufacturing side. The sharing information of the profit ratio of the manufacturing side indicates a profit ratio of the provisional profit of the manufacturing side to an original profit of the manufacturing side.

Until the provisional order amount of the manufacturing side, the provisional distribution amount of the manufacturing side, and the profit ratio of the manufacturing side converge, the order receiving side apparatus 202 may recalculate the provisional order amount of the manufacturing side, the provisional distribution amount of the manufacturing side, and the sharing information of the profit ratio of the manufacturing side every time the commonization penalty and the profit ratio penalty are updated. The order receiving side apparatus 202 transmits the calculated provisional order amount of the manufacturing side and the calculated provisional distribution amount of the manufacturing side to the management side apparatus 201-1 via the network 210. The order receiving side apparatus 202 transmits the calculated sharing information of the profit ratio of the manufacturing side to the management side apparatus 201-2 via the network 210.

The ordering side apparatus 203 acquires confidential information of the retail side, based on an operation input of a retail side user. The confidential information of the retail side includes demand information of the consumer for the product, a provisional profit of the retail side, and the like. For example, the demand information includes a probability distribution indicating the demand of the consumer. The ordering side apparatus 203 stores a commonization penalty and a profit ratio penalty. The commonization penalty and the profit ratio penalty are initialized as predetermined values. For example, the predetermined value is 0.

Every time the commonization penalty is received from the management side apparatus 201, the ordering side apparatus 203 updates the stored commonization penalty with the received commonization penalty. Every time the profit ratio penalty is received from the management side apparatus 201, the ordering side apparatus 203 updates the stored profit ratio penalty with the received profit ratio penalty.

Based on the confidential information of the retail side, the commonization penalty, and the profit ratio penalty, the ordering side apparatus 203 calculates a provisional order amount of the retail side, a provisional distribution amount of the retail side, and sharing information of a profit ratio of the retail side. The provisional order amount of the retail side indicates an order amount of a product ordered from the retail side to the manufacturing side, which is provisionally determined by the retail side. The provisional distribution amount of the retail side indicates a profit amount to be distributed from the manufacturing side to the retail side, which is provisionally determined by the retail side. The sharing information of the profit ratio of the retail side indicates a profit ratio of the provisional profit of the retail side to an original profit of the retail side.

Until the provisional order amount of the retail side, the provisional distribution amount of the retail side, and the profit ratio of the retail side converge, the ordering side apparatus 203 may recalculate the provisional order amount of the retail side, the provisional distribution amount of the retail side, and the sharing information of the profit ratio of the retail side every time the commonization penalty and the profit ratio penalty are updated. The ordering side apparatus 203 transmits the calculated provisional order amount of the retail side and the calculated provisional distribution amount of the retail side to the management side apparatus 201-1 via the network 210. The ordering side apparatus 203 transmits the calculated sharing information of the profit ratio of the retail side to the management side apparatus 201-2 via the network 210.

Until the provisional order amount of the retail side, the provisional distribution amount of the retail side, and the profit ratio of the retail side converge, the ordering side apparatus 203 may recalculate the provisional order amount of the retail side, the provisional distribution amount of the retail side, and the sharing information of the profit ratio of the retail side every time the commonization penalty and the profit ratio penalty are updated. The ordering side apparatus 203 transmits the calculated provisional order amount of the retail side, the calculated provisional distribution amount of the retail side, and the calculated sharing information of the profit ratio of the retail side to the management side apparatus 201 via the network 210.

The management side apparatus 201-1 receives the provisional order amount of the manufacturing side and the provisional distribution amount of the manufacturing side from the order receiving side apparatus 202 via the network 210. The management side apparatus 201-1 receives the provisional order amount of the retail side and the provisional distribution amount of the retail side from the ordering side apparatus 203 via the network 210.

Every time the provisional order amount of the manufacturing side, the provisional distribution amount of the manufacturing side, the provisional order amount of the retail side, and the provisional distribution amount of the retail side are received, the management side apparatus 201-1 calculates a commonization penalty. For example, the management side apparatus 201-1 calculates the commonization penalty, based on the provisional order amount of the manufacturing side, the provisional distribution amount of the manufacturing side, the provisional order amount of the retail side, and the provisional distribution amount of the retail side.

By transmitting the calculated commonization penalty to the order receiving side apparatus 202, the management side apparatus 201-1 updates the commonization penalty stored in the order receiving side apparatus 202. By transmitting the calculated commonization penalty to the ordering side apparatus 203, the management side apparatus 201-1 updates the commonization penalty stored in the ordering side apparatus 203.

The management side apparatus 201-2 receives the sharing information of the profit ratio of the manufacturing side from the order receiving side apparatus 202 via the network 210. The sharing information of the profit ratio of the retail side is received from the ordering side apparatus 203 via the network 210.

Every time the sharing information of the profit ratio of the manufacturing side and the sharing information of the profit ratio of the retail side are received, the management side apparatus 201-2 calculates a profit ratio penalty, based on the sharing information of the profit ratio of the manufacturing side and the sharing information of the profit ratio of the retail side.

By transmitting the calculated profit ratio penalty to the order receiving side apparatus 202, the management side apparatus 201-2 updates the profit ratio penalty stored in the order receiving side apparatus 202. By transmitting the calculated profit ratio penalty to the ordering side apparatus 203, the management side apparatus 201-2 updates the profit ratio penalty stored in the ordering side apparatus 203. Next, the description continues with reference to FIG. 13, and a specific example of computation by the management side apparatus 201-1 and the management side apparatus 201-2 will be described.

As illustrated in FIG. 13, the order receiving side apparatus 202 has confidential information of a manufacturing side. For example, the confidential information of the manufacturing side includes a manufacturing cost c and an original profit tₘ of the manufacturing side. The order receiving side apparatus 202 has the commonization penalty µ and the profit ratio penalty v.

Based on the confidential information of the manufacturing side, the commonization penalty µ, and the profit ratio penalty v, the order receiving side apparatus 202 calculates a provisional order amount qₘ of the manufacturing side and a provisional distribution amount dₘ of the manufacturing side. Based on the confidential information of the manufacturing side, the provisional order amount qₘ of the manufacturing side, and the provisional distribution amount dₘ of the manufacturing side, the order receiving side apparatus 202 calculates a profit ratio ⊓ₘ(qₘ, dₘ)/tₘ of the provisional profit ⊓ₘ(qₘ, dₘ) to the original profit tₘ of the manufacturing side.

The order receiving side apparatus 202 transmits a matrix [qₘ dₘ]^{T} including the calculated provisional order amount qₘ of the manufacturing side and the provisional distribution amount dₘ of the manufacturing side to the management side apparatus 201-1. The order receiving side apparatus 202 transmits the calculated profit ratio ⊓ₘ(qₘ, dₘ)/tₘ of the manufacturing side to the management side apparatus 201-2. The specific example of computation by the order receiving side apparatus 202 has the same manner as the example in FIG. 10, for example.

As illustrated in FIG. 13, the ordering side apparatus 203 has confidential information of a retail side. For example, the confidential information of the retail side includes a consumer demand function f₍ₓ₎ and the original profit tᵣ of the retail side. The ordering side apparatus 203 has the commonization penalty µ and the profit ratio penalty v.

Based on the confidential information of the retail side, the commonization penalty µ, and the profit ratio penalty v, the ordering side apparatus 203 calculates a provisional order amount qᵣ of the retail side and a provisional distribution amount dᵣ of the retail side. The ordering side apparatus 203 calculates a profit ratio ⊓ᵣ(qᵣ, dᵣ)/tᵣ of the provisional profit ⊓ᵣ(qᵣ, dᵣ) to the original profit tᵣ of the retail side, based on confidential information of the retail side, a provisional order amount qᵣ of the retail side, and the provisional distribution amount dᵣ of the retail side.

The ordering side apparatus 203 transmits a matrix [qᵣ dᵣ]^{T} including the calculated provisional order amount of the retail side qᵣ and the calculated provisional distribution amount of the retail side dᵣ to the management side apparatus 201-1. The ordering side apparatus 203 transmits the calculated profit ratio ⊓ᵣ(qᵣ, dᵣ)/tᵣ of the retail side to the management side apparatus 201-2. The specific example of computation by the ordering side apparatus 203 has the same manner as the example in FIG. 11, for example.

As illustrated in FIG. 13, the management side apparatus 201-1 includes the computation units 1301 to 1303. The management side apparatus 201-1 receives the matrix [qₘ dₘ]^{T} of the manufacturing side from the order receiving side apparatus 202. A management side apparatus 201-1 receives the matrix [qᵣ dᵣ]^{T} of the retail side from the ordering side apparatus 203.

The computation unit 1301 calculates a difference obtained by subtracting the matrix [qᵣ dᵣ]^{T} of the retail side from the matrix [qₘ dₘ]^{T} of the manufacturing side, and transmits the difference to the computation units 1302 and 1303. The computation unit 1302 receives the difference, calculates an integral value of the received difference, and transmits the integral value to the computation unit 1303. By adding the difference and the integral value, the computation unit 1303 calculates the commonization penalty µ. The management side apparatus 201-1 transmits the commonization penalty µ to the order receiving side apparatus 202 and the ordering side apparatus 203.

As illustrated in FIG. 13, the management side apparatus 201-2 includes the computation units 1311 to 1313. The management side apparatus 201-2 receives the profit ratio ⊓ₘ(qₘ, dₘ)/tₘ of the manufacturing side from the order receiving side apparatus 202. The management side apparatus 201-2 receives the profit ratio ⊓ᵣ(qᵣ, dᵣ)/tᵣ of the retail side from the ordering side apparatus 203.

The computation unit 1311 calculates a difference obtained by subtracting the profit ratio ⊓ᵣ(qᵣ, dᵣ)/tᵣ of the retail side from the profit ratio ⊓ₘ(qₘ, dₘ)/tₘ of the manufacturing side, and transmits the difference to the computation units 1312 and 1313. The computation unit 1312 receives the difference, calculates an integral value of the received difference, and transmits the integral value to the computation unit 1313. By adding the difference and the integral value, the computation unit 1313 calculates the profit ratio penalty v. The management side apparatus 201-2 transmits the profit ratio penalty v to the order receiving side apparatus 202 and the ordering side apparatus 203.

Therefore, the management side apparatus 201-1 may cause the manufacturing side to adjust the provisional order amount qₘ of the manufacturing side and may cause the retail side to adjust the provisional order amount qᵣ of the retail side so that the provisional order amount qₘ of the manufacturing side and the provisional order amount qᵣ of the retail side coincide with each other. The management side apparatus 201-1 may cause the manufacturing side to adjust the provisional distribution amount dₘ of the manufacturing side and cause the retail side to adjust the provisional distribution amount dᵣ of the retail side so that the provisional distribution amount dₘ of the manufacturing side and the provisional distribution amount dᵣ of the retail side coincide with each other. The management side apparatus 201-1 may maximize a profit of the entire supply chain.

The management side apparatus 201-2 may cause the manufacturing side to adjust the provisional profit ⊓ₘ(qₘ, dₘ) of the manufacturing side so that the profit ratio ⊓ₘ(qₘ, dₘ)/tₘ of the manufacturing side and the profit ratio ⊓ᵣ(qᵣ, dᵣ)/tᵣ of the retail side coincide with each other. The management side apparatus 201-2 may cause the retail side to adjust the provisional profit ⊓ᵣ(qᵣ, dᵣ) of the retail side so that the profit ratio ⊓ₘ(qₘ, dₘ)/tₘ of the manufacturing side and the profit ratio ⊓ᵣ(qᵣ, dᵣ)/tᵣ of the retail side coincide with each other. For maximizing the profit of the entire supply chain, the management side apparatus 201-2 may enable the manufacturing side and the retail side to fairly maximize the profits.

In this manner, the information processing system 200 may maximize the profit of the entire supply chain even when the retail side and the manufacturing side do not make the confidential information public.

The information processing system 200 may distribute the provisional order amount qₘ of the manufacturing side, the provisional distribution amount dₘ of the manufacturing side, and the profit ratio ⊓ₘ(qₘ, dₘ)/tₘ of the manufacturing side to the management side apparatus 201-1 and the management side apparatus 201-2 not to be collected in one computer. For this reason, the information processing system 200 may reduce the existence of a computer capable of estimating the confidential information of the manufacturing side, based on a history of the provisional order amount qₘ of the manufacturing side, the provisional distribution amount dₘ of the manufacturing side, and the profit ratio ⊓ₘ(qₘ, dₘ)/tₘ of the manufacturing side. For this reason, the information processing system 200 may suppress leakage of the confidential information of the manufacturing side.

The information processing system 200 may distribute the provisional order amount qᵣ of the retail side, the provisional distribution amount dᵣ of the retail side, and the profit ratio ⊓ᵣ(qᵣ, dᵣ)/tᵣ of the retail side to the management side apparatus 201-1 and the management side apparatus 201-2 not to be collected in one computer. For this reason, the information processing system 200 may reduce the existence of a computer capable of estimating the confidential information of the retail side, based on a history of the provisional order amount qᵣ of the retail side, the provisional distribution amount dᵣ of the retail side, and the profit ratio ⊓ᵣ(qᵣ, dᵣ)/tᵣ of the retail side. For this reason, the information processing system 200 may suppress leakage of the confidential information of the retail side.

### Example of Effect by Information Processing System 200

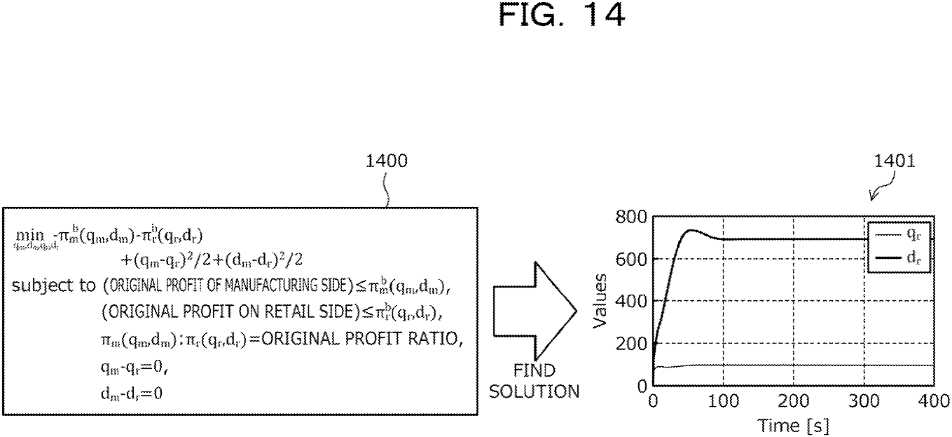

Next, an example of effects of the information processing system 200 will be described with reference to FIG. 14.

FIG. 14 is an explanatory diagram illustrating the example of the effects obtained by the information processing system 200. As illustrated in FIG. 14, the information processing system 200 may solve an optimization problem 1400 for maximizing a profit of an entire supply chain. For example, the optimization problem 1400 includes an evaluation function represented by the following equation (15).

$${min}_{{q}_{m} , {d}_{m} , {q}_{r} , {d}_{r}} - {π}_{m}^{b} \left({q}_{m} , {d}_{m}\right) - {π}_{r}^{b} \left({q}_{r} , {d}_{r}\right) + {\left({q}_{m} - {q}_{r}\right)}^{2} / 2 + {\left({d}_{m} - {d}_{r}\right)}^{2} / 2$$

An evaluation function indicates that a provisional profit ⊓ₘ^{b}(qₘ, dₘ) of a manufacturing side and a provisional profit ⊓ᵣ^{b}(qᵣ, dᵣ) of a retail side are maximized. An evaluation function indicates that a difference between a provisional order amount qₘ of the manufacturing side and a provisional order amount qᵣ of the retail side and a difference between a provisional distribution amount dₘ of the manufacturing side and a provisional distribution amount dᵣ of the retail side are minimized.

For example, the optimization problem 1400 includes a constraint condition “(original profit of manufacturing side) ≤ ⊓ₘ^{b}(qₘ, dₘ)” and a constraint condition “(original profit of retail side) ≤ ⊓ᵣ^{b}(qᵣ, dᵣ)”. For example, the optimization problem 1400 includes a constraint condition “⊓ₘ^{b}(qₘ, dₘ): ⊓ᵣ^{b}(qᵣ, dᵣ) = original profit of manufacturing side: original profit of retail side”. For example, the optimization problem 1400 includes a constraint condition “difference between provisional order amount qₘ of manufacturing side and provisional order amount qᵣ of retail side = 0” and a constraint condition “difference between provisional distribution amount dₘ of manufacturing side and provisional distribution amount dᵣ of retail side = 0”.

By introducing the provisional distribution amount dₘ on the manufacturing side and the provisional distribution amount dᵣ of the retail side, the optimization problem 1400 is reduced to a distributable convex optimization problem, and the evaluation function is a convex function with respect to decision variables. For this reason, in the information processing system 200, the management side apparatus 201, the order receiving side apparatus 202, and the ordering side apparatus 203 may solve the optimization problem 1400 by performing a distributed process on the optimization problem 1400.

The decision variables are the provisional order amount qₘ of the manufacturing side, the provisional distribution amount dₘ of the manufacturing side, the provisional order amount qᵣ of the retail side, and the provisional distribution amount dᵣ of the retail side. With the distributable convex optimization problem, the evaluation function and the constraint condition do not have to be shared between computers that perform the distributed process on the optimization problem 1400. For this reason, the information processing system 200 may solve the optimization problem 1400 even when confidential information of the manufacturing side and confidential information of the retail side are not made public.

According to the constraint condition, the information processing system 200 may make the provisional profit ⊓ₘ^{b}(qₘ, dₘ) of the manufacturing side larger than the original profit. According to the constraint condition, the information processing system 200 may make the provisional profit ⊓ᵣ^{b}(qᵣ, dᵣ) on the retail side larger than the original profit. The information processing system 200 may maintain a fixed profit ratio between the provisional profit ⊓ₘ^{b}(qₘ, dₘ) of the manufacturing side and the provisional profit ⊓ᵣ^{b}(qᵣ, dᵣ) of the retail side.

In this manner, with the information processing system 200, both the manufacturing side and the retail side may not suffer from disadvantages. For example, it is conceivable to adopt values at a time of double marginalization as the original profit of the manufacturing side and the original profit of the retail side. By contrast, in the information processing system 200, both the manufacturing side and the retail side may not suffer from the disadvantage, as compared with a case of the double marginalization serving as a base.

For example, as illustrated in a graph 1401, the information processing system 200 may optimize the provisional order amount of the retail side qᵣ and the provisional distribution amount of the retail side dᵣ, and make the provisional order amount of the retail side qᵣ and the provisional distribution amount of the retail side dᵣ converge. A thin line in the graph 1401 indicates the provisional order amount qᵣ of the retail side. A thick line in the graph 1401 indicates the provisional distribution amount dᵣ of the retail side. For example, in the same manner, the information processing system 200 may make the provisional order amount qₘ of the manufacturing side and the provisional distribution amount dₘ of the manufacturing side converge.

As illustrated in the graph 1401, the information processing system 200 may make the convergence of qₘ = qᵣ = 97.4 and dₘ = dᵣ =695. In this case, the provisional profit ⊓ₘ^{b}(97.4, 695) of the manufacturing side is 2230, and the provisional profit ⊓ᵣ^{b}(97.4, 695) of the retail side is 2050. By contrast, in an initial state, the original profit of the manufacturing side is 1980 and the original profit of the retail side is 1820. In this manner, the information processing system 200 may maximize the profit of the entire supply chain while maintaining a fixed profit ratio between the provisional profit ⊓ₘ^{b}(qₘ, dₘ) of the manufacturing side and the provisional profit ⊓ᵣ^{b}(qᵣ, dᵣ) of the retail side.

### Order Receiving Side Calculation Process Procedure

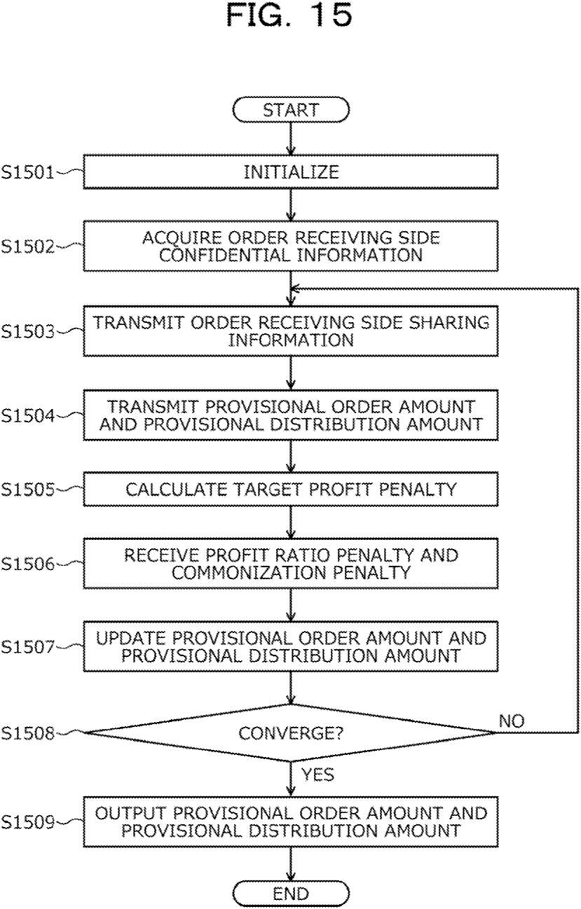

Next, an example of an order receiving side calculation process procedure executed by the order receiving side apparatus 202 will be described with reference to FIG. 15. An order receiving side calculation process is implemented by, for example, the CPU 401, a storage region such as the memory 402 or the recording medium 405, and the network I/F 403 illustrated in FIG. 4.

FIG. 15 is a flowchart illustrating the example of the order receiving side calculation process procedure. As illustrated in FIG. 15, the order receiving side apparatus 202 initializes a provisional profit, a provisional order amount, a provisional distribution amount, a profit ratio penalty, and a commonization penalty (step S1501).

Next, the order receiving side apparatus 202 acquires order receiving side confidential information including a manufacturing cost of a product, an original profit of an order receiving side, and the like (step S1502). Based on the order receiving side confidential information, the order receiving side apparatus 202 transmits order receiving side sharing information including a ratio of the provisional profit to the original profit of the order receiving side to the management side apparatus 201 (step S1503).

Next, the order receiving side apparatus 202 transmits the provisional order amount and the provisional distribution amount to the management side apparatus 201 (step S1504). The order receiving side apparatus 202 calculates a target profit achievement degree based on the provisional order amount and the provisional distribution amount, and calculates a target profit penalty based on the calculated target profit achievement degree (step S1505).

After that, the order receiving side apparatus 202 receives the profit ratio penalty and the commonization penalty from the management side apparatus 201 (step S1506). By using the order receiving side confidential information, the profit ratio penalty, the commonization penalty, and the target profit penalty as parameters, the order receiving side apparatus 202 updates the provisional order amount and the provisional distribution amount (step S1507).

Next, the order receiving side apparatus 202 determines whether or not the provisional order amount and the provisional distribution amount converge (step S1508). In a case where the convergence is not made (No in step S1508), the order receiving side apparatus 202 returns to the process in step S1503. By contrast, in a case where the convergence is made (Yes in step S1508), the order receiving side apparatus 202 proceeds to the process in step S1509.

At step S1509, the order receiving side apparatus 202 outputs the provisional order amount and the provisional distribution amount, as a determined order amount and a determined distribution amount (step S1509). The order receiving side apparatus 202 ends the order receiving side calculation process. Therefore, the order receiving side apparatus 202 may calculate the determined order amount and the determined distribution amount for maximizing a profit of an entire supply chain, and an order receiving side user may recognize the determined order amount and the determined distribution amount.

### Ordering Side Calculation Process Procedure

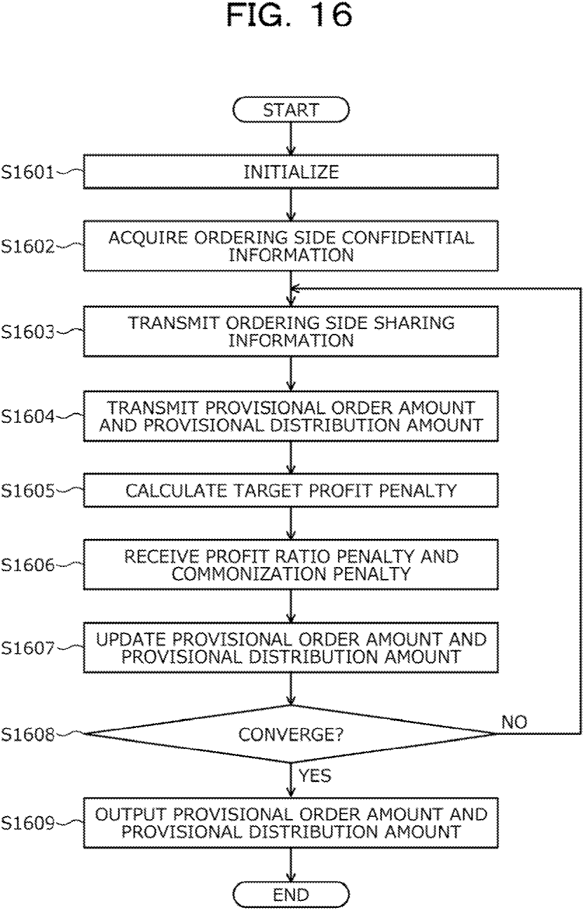

Next, an example of an ordering side calculation process procedure executed by the ordering side apparatus 203 will be described with reference to FIG. 16. An ordering side calculation process is implemented by, for example, the CPU 501, a storage region such as the memory 502 or the recording medium 505, and the network I/F 503 illustrated in FIG. 5.

FIG. 16 is a flowchart illustrating the example of the ordering side calculation process procedure. As illustrated in FIG. 16, the ordering side apparatus 203 initializes a provisional profit, a provisional order amount, a provisional distribution amount, a profit ratio penalty, and a commonization penalty (step S1601).

Next, the ordering side apparatus 203 acquires ordering side confidential information including demand information of a consumer, an original profit of an ordering side, and the like (step S1602). Based on the ordering side confidential information, the ordering side apparatus 203 transmits ordering side sharing information including a ratio of the provisional profit to the original profit of the ordering side to the management side apparatus 201 (step S1603).

Next, the ordering side apparatus 203 transmits the provisional order amount and the provisional distribution amount to the management side apparatus 201 (step S1604). The ordering side apparatus 203 calculates a target profit achievement degree based on the provisional order amount and the provisional distribution amount, and calculates a target profit penalty based on the calculated target profit achievement degree (step S1605).

Next, the ordering side apparatus 203 receives the profit ratio penalty and the commonization penalty from the management side apparatus 201 (step S1606). By using the ordering side confidential information, the profit ratio penalty, the commonization penalty, and the target profit penalty as parameters, the ordering side apparatus 203 updates the provisional order amount and the provisional distribution amount (step S1607).

Next, the ordering side apparatus 203 determines whether or not the provisional order amount and the provisional distribution amount converge (step S1608). In a case where the convergence is not made (No in step S1608), the ordering side apparatus 203 returns to the process in step S1603. By contrast, in a case where the convergence is made (Yes in step S1608), the ordering side apparatus 203 proceeds to the process in step S1609.

At step S1609, the ordering side apparatus 203 outputs the provisional order amount and the provisional distribution amount as a determined order amount and a determined distribution amount (step S1609). The ordering side apparatus 203 ends the ordering side calculation process. Therefore, the ordering side apparatus 203 may calculate the determined order amount and the determined distribution amount for maximizing a profit of an entire supply chain, and an ordering side user may recognize the determined order amount and the determined distribution amount.

### First Penalty Calculation Process Procedure

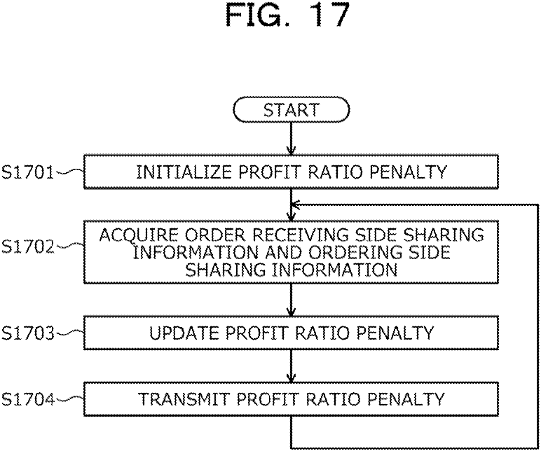

Next, an example of a first penalty calculation process procedure executed by the management side apparatus 201 will be described with reference to FIG. 17. A first penalty calculation process is implemented by, for example, the CPU 301, a storage region such as the memory 302 or the recording medium 305, and the network I/F 303 illustrated in FIG. 3.

FIG. 17 is a flowchart illustrating the example of the first penalty calculation process procedure. As illustrated in FIG. 17, the management side apparatus 201 initializes a profit ratio penalty (step S1701).

Next, the management side apparatus 201 acquires order receiving side sharing information and ordering side sharing information (step S1702). Based on the acquired order receiving side sharing information and ordering side sharing information, the management side apparatus 201 updates the profit ratio penalty (step S1703).

Next, the management side apparatus 201 transmits the updated profit ratio penalty to the order receiving side apparatus 202 and the ordering side apparatus 203 (step S1704). The management side apparatus 201 returns to the process in step S1702. Therefore, the management side apparatus 201 may control the order receiving side apparatus 202 and the ordering side apparatus 203 so that a provisional profit of an order receiving side and a provisional profit of an ordering side coincide with each other.

### Second Penalty Calculation Process Procedure

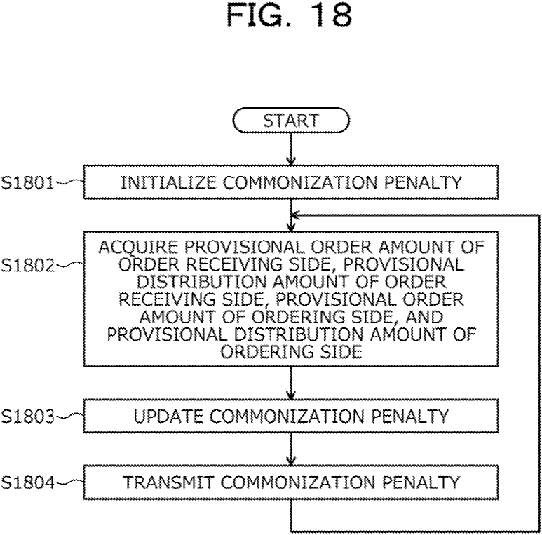

Next, an example of a second penalty calculation process procedure executed by the management side apparatus 201 will be described with reference to FIG. 18. A second penalty calculation process is implemented by, for example, the CPU 301, a storage region such as the memory 302 or the recording medium 305, and the network I/F 303 illustrated in FIG. 3.

FIG. 18 is a flowchart illustrating the example of the second penalty calculation process procedure. As illustrated in FIG. 18, the management side apparatus 201 initializes a commonization penalty (step S1801).

After that, the management side apparatus 201 acquires a provisional order amount of an order receiving side, a provisional distribution amount of the order receiving side, a provisional order amount of an ordering side, and a provisional distribution amount of the ordering side (step S1802). Based on the acquired provisional order amount of the order receiving side, provisional distribution amount of the order receiving side, provisional order amount of the ordering side, and provisional distribution amount of the ordering side, the management side apparatus 201 updates the commonization penalty (step S1803).

Next, the management side apparatus 201 transmits the updated commonization penalty to the order receiving side apparatus 202 and the ordering side apparatus 203 (step S1804). The management side apparatus 201 returns to the process in step S1802. Therefore, the management side apparatus 201 may control the order receiving side apparatus 202 and the ordering side apparatus 203 so that the provisional order amount of the order receiving side and the provisional order amount of the ordering side coincide with each other and the provisional distribution amount of the order receiving side and the provisional distribution amount of the ordering side coincide with each other.

The management side apparatus 201 may change and execute the order of the processes of some steps illustrated in each flowchart in FIGS. 15 to 18. For example, the order of the processes in steps S1503 and S1504 may be changed. For example, the order of the processes in steps S1603 and S1604 may be changed. The management side apparatus 201 may omit the process in some steps in each flowchart in FIGS. 15 to 18.

As described above, with the management side apparatus 201, it is possible to acquire, from the order receiving side, the first order quantity and the first profit amount calculated by the order receiving side by using the first parameter including the first confidential information owned by the order receiving side. With the management side apparatus 201, it is possible to acquire, from the ordering side, the second order quantity and the second profit amount calculated by the ordering side by using the second parameter including the second confidential information owned by the ordering side. With the management side apparatus 201, it is possible to calculate, based on the acquired first order quantity, first profit amount, second order quantity, and second profit amount, the first penalty acting to reduce the difference between the first order quantity and the second order quantity and the difference between the first profit amount and the second profit amount. With the management side apparatus 201, it is possible to notify the order receiving side to calculate the first order quantity and the first profit amount by using the first parameter including the calculated first penalty. With the management side apparatus 201, it is possible to notify the ordering side to calculate the second order quantity and the second profit amount by using the second parameter including the calculated first penalty. Therefore, the management side apparatus 201 may maximize the profit of the entire supply chain.

With the management side apparatus 201, it is possible to acquire, from the order receiving side, the first order quantity and the first profit amount calculated by the order receiving side by using the first parameter including the first penalty. With the management side apparatus 201, it is possible to acquire, from the ordering side, the second order quantity and the second profit amount calculated by the ordering side by using the second parameter including the first penalty. With the management side apparatus 201, it is possible to update the first penalty based on the first order quantity, the first profit amount, the second order quantity, and the second profit amount which are acquired in the current time. With the management side apparatus 201, it is possible to notify the order receiving side to calculate the first order quantity and the first profit amount by using the first parameter including the updated first penalty. With the management side apparatus 201, it is possible to notify the ordering side to calculate the second order quantity and the second profit amount by using the second parameter including the updated first penalty. Therefore, the management side apparatus 201 may repeatedly maximize the profit of the entire supply chain.

With the management side apparatus 201, it is possible to acquire, from the order receiving side, the first ratio of the provisional profit obtained by the order receiving side to the original profit obtained by the order receiving side, which is calculated by the order receiving side by using the first parameter. With the management side apparatus 201, it is possible to acquire, from the ordering side, the second ratio of the provisional profit obtained by the ordering side to the original profit obtained by the ordering side, which is calculated by the ordering side by using the second parameter. With the management side apparatus 201, it is possible to calculate the second penalty acting to reduce the difference between the first ratio and the second ratio based on the acquired first ratio and second ratio. With the management side apparatus 201, it is possible to notify the order receiving side to calculate the first order quantity, the first profit amount, and the first ratio by using the first parameter including the first penalty and the calculated second penalty. With the management side apparatus 201, it is possible to notify the ordering side to calculate the second order quantity, the second profit amount, and the second ratio by using the second parameter including the first penalty and the calculated second penalty. Therefore, the management side apparatus 201 may maintain the profit ratio between the provisional profit obtained by the order receiving side and the provisional profit obtained by the ordering side.

With the management side apparatus 201, it is possible to acquire, from the order receiving side, the first ratio calculated by the order receiving side by using the first parameter including the first penalty and the second penalty. With the management side apparatus 201, it is possible to acquire, from the ordering side, the second ratio calculated by the ordering side by using the second parameter including the first penalty and the second penalty. With the management side apparatus 201, it is possible to update the second penalty acting to reduce the difference between the first ratio and the second ratio, based on the first ratio and the second ratio which are acquired in the current time. With the management side apparatus 201, it is possible to notify the order receiving side to calculate the first order quantity, the first profit amount, and the first ratio by using the first parameter including the first penalty and the updated second penalty. With the management side apparatus 201, it is possible to notify the ordering side to calculate the second order quantity, the second profit amount, and the second ratio by using the second parameter including the first penalty and the updated second penalty. Therefore, the management side apparatus 201 may maintain the profit ratio between the provisional profit obtained by the order receiving side and the provisional profit obtained by the ordering side.

The management side apparatus 201 may be applied to a case where the order receiving side is a providing side that provides a product to the ordering side, and the ordering side is a selling side that sells the product to a consumer. The management side apparatus 201 may be applied to a case where the first confidential information includes the cost of the product and the original profit obtained by the order receiving side, and the second confidential information includes the demand information of the product and the original profit obtained by the ordering side. Therefore, the management side apparatus 201 may maximize the profit of the entire supply chain including the providing side that provides the product to the ordering side and the selling side that sells the product to the consumer.

With the management side apparatus 201, it is possible to add the difference value obtained by subtracting the second matrix including the acquired second order quantity and second profit amount from the first matrix including the acquired first order quantity and first profit amount, and the integral value of the difference value. Therefore, the management side apparatus 201 may calculate the first penalty with high accuracy.

With the management side apparatus 201, it is possible to add the difference value obtained by subtracting the acquired second ratio from the acquired first ratio and the integral value of the difference value. Therefore, the management side apparatus 201 may calculate the second penalty with high accuracy.

With the order receiving side apparatus 202, it is possible to calculate the first order quantity from the order receiving side to the ordering side and the first profit amount distributed from the order receiving side to the ordering side by using the first parameter including the first confidential information of the order receiving side. With the order receiving side apparatus 202, it is possible to transmit the calculated first order quantity and first profit amount to the management side apparatus 201. With the order receiving side apparatus 202, it is possible to receive, from the management side apparatus 201, the first penalty acting to reduce the difference between the first order quantity and the second order quantity and the difference between the first profit amount and the second profit amount. With the order receiving side apparatus 202, it is possible to calculate the first order quantity and the first profit amount by using the first parameter including the received first penalty. Therefore, the order receiving side apparatus 202 may optimize the first order quantity and the first profit amount.

With the order receiving side apparatus 202, it is possible to output the calculated first order quantity and first profit amount in a case where the first penalty indicates that the first order quantity and the second order quantity coincide with each other and the first profit amount and the second profit amount coincide with each other. Therefore, the order receiving side apparatus 202 may detect that the first order quantity and the first profit amount converge, and may enable the order receiving side user to refer to the appropriate first order quantity and first profit amount.

With the ordering side apparatus 203, it is possible to calculate the first order quantity from the order receiving side to the ordering side and the first profit amount distributed from the order receiving side to the ordering side by using the first parameter including the first confidential information of the ordering side. With the ordering side apparatus 203, it is possible to transmit the calculated first order quantity and first profit amount to the management side apparatus 201. With the ordering side apparatus 203, it is possible to receive, from the management side apparatus 201, the first penalty acting to reduce the difference between the first order quantity and the second order quantity and the difference between the first profit amount and the second profit amount. With the ordering side apparatus 203, it is possible to calculate the first order quantity and the first profit amount by using the first parameter including the received first penalty. Therefore, the ordering side apparatus 203 may optimize the first order quantity and the first profit amount.

With the ordering side apparatus 203, it is possible to output the calculated first order quantity and first profit amount in a case where the first penalty indicates that the first order quantity and the second order quantity coincide with each other and the first profit amount and the second profit amount coincide with each other. Therefore, the ordering side apparatus 203 may detect that the first order quantity and the first profit amount converge, and may enable the ordering side user to refer to the appropriate first order quantity and first profit amount.

The information processing method described in the present embodiment may be implemented by executing a program prepared in advance by a computer, such as a PC or a workstation. The information processing program described in the present embodiment is recorded on a computer-readable recording medium. The information processing program is read from the recording medium by the computer and is executed by the computer. The recording medium is a hard disk, a flexible disk, a compact disc (CD)-ROM, a magneto-optical (MO) disc, a Digital Versatile Disc (DVD), or the like. The information processing program described in the present embodiment may be distributed via a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program causing a computer to execute a process comprising:
acquiring a first order quantity from an order receiving side to an ordering side and a first profit amount distributed from the order receiving side to the ordering side, which are calculated by the order receiving side by using a first parameter including first confidential information owned by the order receiving side, from the order receiving side;
acquiring a second order quantity from the order receiving side to the ordering side and a second profit amount distributed from the order receiving side to the ordering side, which are calculated by the ordering side by using a second parameter including second confidential information owned by the ordering side, from the ordering side;
calculating a first penalty that acts to reduce a difference between the first order quantity and the second order quantity and a difference between the first profit amount and the second profit amount, based on the acquired first order quantity, the acquired first profit amount, the acquired second order quantity, and the acquired second profit amount;
notifying the order receiving side to calculate the first order quantity and the first profit amount by using the first parameter including the calculated first penalty; and
notifying the ordering side to calculate the second order quantity and the second profit amount by using the second parameter including the calculated first penalty.

2. The non-transitory computer-readable recording medium according to claim 1,
wherein in the acquiring of the first order quantity and the first profit amount,
the first order quantity and the first profit amount, which are calculated by the order receiving side by using the first parameter including the first penalty, are acquired from the order receiving side,
in the acquiring of the second order quantity and the second profit amount,
the second order quantity and the second profit amount, which are calculated by the ordering side by using the second parameter including the first penalty, are acquired from the ordering side,
in the calculating of the first penalty,
the first penalty is updated based on the first order quantity, the first profit amount, the second order quantity, and the second profit amount, which are acquired in a current time,
in the notifying of the order receiving side,
the order receiving side is notified to calculate the first order quantity and the first profit amount by using the first parameter including the updated first penalty, and
in the notifying of the ordering side,
the ordering side is notified to calculate the second order quantity and the second profit amount by using the second parameter including the updated first penalty.

3. The non-transitory computer-readable recording medium according to claim 1,
wherein the information processing program causes the computer to execute a process of
acquiring a first ratio of a provisional profit obtained by the order receiving side to an original profit obtained by the order receiving side, which is calculated by the order receiving side by using the first parameter, from the order receiving side,
acquiring a second ratio of a provisional profit obtained by the ordering side to an original profit obtained by the ordering side, which is calculated by the ordering side by using the second parameter, from the ordering side, and
calculating a second penalty that acts to reduce a difference between the first ratio and the second ratio, based on the acquired first ratio and the acquired second ratio,
in the notifying of the order receiving side,
the order receiving side is notified to calculate the first order quantity, the first profit amount, and the first ratio by using the first parameter including the first penalty and the calculated second penalty, and
in the notifying of the ordering side,
the ordering side is notified to calculate the second order quantity, the second profit amount, and the second ratio by using the second parameter including the first penalty and the calculated second penalty.

4. The non-transitory computer-readable recording medium according to claim 3,
wherein in the acquiring of the first ratio,
the first ratio calculated by the order receiving side by using the first parameter including the first penalty and the second penalty is acquired from the order receiving side,
in the acquiring of the second ratio,
the second ratio calculated by the ordering side by using the second parameter including the first penalty and the second penalty is acquired from the ordering side,
in the calculating of the second penalty,
the second penalty that acts to reduce the difference between the first ratio and the second ratio is updated based on the first ratio and the second ratio, which are acquired in a current time,
in the notifying of the order receiving side,
the order receiving side is notified to calculate the first order quantity, the first profit amount, and the first ratio by using the first parameter including the first penalty and the updated second penalty, and
in the notifying of the ordering side,
the ordering side is notified to calculate the second order quantity, the second profit amount, and the second ratio by using the second parameter including the first penalty and the updated second penalty.

5. The non-transitory computer-readable recording medium according to claim 1,
wherein the order receiving side is a providing side that provides a product to the ordering side,
the ordering side is a selling side that sells the product to a consumer,
the first confidential information includes a cost of the product and an original profit obtained by the order receiving side, and
the second confidential information includes demand information of the product and an original profit obtained by the ordering side.

6. The non-transitory computer-readable recording medium according to claim 1,
wherein in the calculating of the first penalty,
the first penalty is calculated by adding a difference value obtained by subtracting a second matrix including the acquired second order quantity and the acquired second profit amount from a first matrix including the acquired first order quantity and the acquired first profit amount, and an integral value of the difference value.

7. The non-transitory computer-readable recording medium according to claim 3,
wherein in the calculating of the second penalty,
the second penalty is calculated by adding a difference value obtained by subtracting the acquired second ratio from the acquired first ratio and an integral value of the difference value.

8. An information processing system including a first apparatus that corresponds to an order receiving side, a second apparatus that corresponds to an ordering side, and a third apparatus that does not correspond to any of the order receiving side and the ordering side,
the first apparatus being configured to:
calculate a first order quantity from the order receiving side to the ordering side and a first profit amount distributed from the order receiving side to the ordering side by using a first parameter including first confidential information, and transmit the calculated first order quantity and the calculated first profit amount to the third apparatus,
the second apparatus being configured to:
calculate a second order quantity from the order receiving side to the ordering side and a second profit amount distributed from the order receiving side to the ordering side by using a second parameter including second confidential information, and transmit the calculated second order quantity and the calculated second profit amount to the third apparatus, and
the third apparatus being configured to:
receive the first order quantity and the first profit amount, which are calculated by the first apparatus using the first parameter, from the first apparatus,
receive the second order quantity and the second profit amount, which are calculated by the second apparatus by using the second parameter, from the second apparatus,
calculate a first penalty that acts to reduce a difference between the first order quantity and the second order quantity and a difference between the first profit amount and the second profit amount, based on the received first order quantity, the received first profit amount, the received second order quantity, and the received second profit amount,
notify the first apparatus to calculate the first order quantity and the first profit amount by using the first parameter including the calculated first penalty, and
notify the second apparatus to calculate the second order quantity and the second profit amount by using the second parameter including the calculated first penalty.

9. The information processing system according to claim 8,
wherein the first apparatus is configured to:
calculate the first order quantity and the first profit amount by using the first parameter including the first penalty, and transmit the calculated first order quantity and the calculated first profit amount to the third apparatus,
the second apparatus is configured to:
calculate the second order quantity and the second profit amount by using the second parameter including the first penalty, and transmit the calculated second order quantity and the calculated second profit amount to the third apparatus, and
the third apparatus is configured to:
receive the first order quantity and the first profit amount, which are calculated by the first apparatus by using the first parameter including the first penalty, from the first apparatus,
receive the second order quantity and the second profit amount, which are calculated by the second apparatus by using the first parameter including the first penalty, from the second apparatus,
update the first penalty based on the first order quantity, the first profit amount, the second order quantity, and the second profit amount, which are received in a current time,
notify the first apparatus to calculate the first order quantity and the first profit amount by using the first parameter including the updated first penalty, and
notify the second apparatus to calculate the second order quantity and the second profit amount by using the second parameter including the updated first penalty.

10. The information processing system according to claim 8,
wherein the first apparatus is configured to:
calculate a first ratio of a provisional profit obtained by the order receiving side to an original profit obtained by the order receiving side by using the first parameter, and transmit the calculated first ratio to the third apparatus,
the second apparatus is configured to:
calculate a second ratio of a provisional profit obtained by the ordering side to an original profit obtained by the ordering side by using the second parameter, and transmit the calculated second ratio to the third apparatus, and the third apparatus is configured to:
receive the first ratio from the first apparatus,
receive the second ratio from the second apparatus,
calculate a second penalty that acts to reduce a difference between the first ratio and the second ratio, based on the received first ratio and the received second ratio,
notify the first apparatus to calculate the first order quantity, the first profit amount, and the first ratio by using the first parameter including the first penalty and the calculated second penalty, and
notify the second apparatus to calculate the second order quantity, the second profit amount, and the second ratio by using the second parameter including the first penalty and the calculated second penalty.

11. The information processing system according to claim 10,
wherein the first apparatus is configured to:
calculate the first ratio by using the first parameter including the first penalty and the second penalty, and transmit the first ratio to the third apparatus,
the second apparatus is configured to:
calculate the second ratio by using the second parameter including the first penalty and the second penalty, and transmit the second ratio to the third apparatus, and
the third apparatus is configured to:
receive the first ratio calculated by the first apparatus by using the first parameter including the first penalty and the second penalty, from the first apparatus,
receive the second ratio calculated by the second apparatus by using the second parameter including the first penalty and the second penalty, from the second apparatus,
update the second penalty based on the first ratio and the second ratio, which are received in a current time,
notify the first apparatus to calculate the first order quantity, the first profit amount, and the first ratio by using the first parameter including the first penalty and the updated second penalty, and
notify the second apparatus to calculate the second order quantity, the second profit amount, and the second ratio by using the second parameter including the first penalty and the updated second penalty.

12. A non-transitory computer-readable recording medium storing an information processing program causing a computer to execute a process comprising:
calculating a first order quantity from an order receiving side to an ordering side and a first profit amount distributed from the order receiving side to the ordering side, by using a first parameter including first confidential information in the order receiving side;
transmitting the calculated first order quantity and the calculated first profit amount to a management side apparatus that receives a second order quantity from the order receiving side to the ordering side and a second profit amount distributed from the order receiving side to the ordering side, which are calculated by the ordering side, from the ordering side;
receiving a first penalty that acts to reduce a difference between the first order quantity and the second order quantity and a difference between the first profit amount and the second profit amount, which are calculated by the management side apparatus based on the first order quantity, the first profit amount, the second order quantity, and the second profit amount, from the management side apparatus; and
calculating the first order quantity and the first profit amount by using the first parameter including the received first penalty.

13. The non-transitory computer-readable recording medium according to claim 12,
wherein the information processing program causes the computer to execute a process of, when the first penalty is received, outputting the calculated first order quantity and the calculated first profit amount in a case where the first penalty indicates that the first order quantity and the second order quantity coincide with each other and the first profit amount and the second profit amount coincide with each other.
